(19) United States
(12) Patent Application Publication
(10) Pub. No.: US 2026/0008249 A1
(43) Pub. Date: Jan. 8, 2026

(54) METHOD OF MANUFACTURING A MODIFIED ATMOSPHERE PACKAGING CONTAINER

(71) Applicant: Cirkla Inc., Lewes, DE (US)

(72) Inventors: Vaibhav Goel, Mumbai (IN); Aniruddha Deshmukh, Mumbai (IN)

(73) Assignee: Cirkla Inc., Lewes, DE (US)

(21) Appl. No.: 19/050,569

(22) Filed: Feb. 11, 2025

Related U.S. Application Data
(63) Continuation-in-part of application No. 29/969,057, filed on Oct. 21, 2024.

(30) Foreign Application Priority Data
Jul. 8, 2024 (IN) 202421052291
Nov. 13, 2024 (IN) 202411087820

(51) Int. Cl. B32B 1/00; B32B 7/06; B32B 27/12; B32B 27/30; B32B 27/32; B32B 27/34; D21J 5/00

(52) U.S. Cl. CPC B32B 1/00; B32B 7/06; B32B 27/12; B32B 27/306; B32B 27/32; B32B 27/34; D21J 5/00; B32B 2250/05; B32B 2307/7163; B32B 2307/7244; B32B 2307/7246; B32B 2439/00

(57) ABSTRACT

A method of manufacturing a modified atmosphere packaging (MAP) container, comprising forming a molded fiber structure from a slurry comprising a biodegradable fibrous product and water, forming a multi-layered peelable liner having a defined number of layers that are concomitantly layered in a predefined sequential configuration, wherein a plurality of polyamide (PA) layers and an ethylene vinyl alcohol (EVOH) layer are sandwiched between a first set of polyethylene (PE) layers and a second set of PE layers, and removably attaching the multi-layered peelable liner on the molded fiber structure to form the MAP container.

CROSS-REFERENCE TO RELATED APPLICATIONS/INCORPORATION BY Reference

This Application makes reference to, claims priority to, and claims benefit from Indian Provisional Application No. 202421052291 filed on Jul. 8, 2024. This Application further makes reference to, claims priority to, and claims benefit from Indian Provisional Application No. 202411087820 filed on Nov. 13, 2024. This Application makes reference to, claims priority to, and claims benefit from U.S. design application No. 29/969,057 filed on Oct. 21, 2024.

The above-referenced Applications are hereby incorporated herein by reference in their entirety.

### FIELD OF TECHNOLOGY

The present disclosure generally relates to the field of environment-friendly packaging solutions, and more specifically, to a method for manufacturing a modified atmosphere packaging (MAP) container.

### BACKGROUND

Packaging is commonly used to protect and store products, including food, during storage, shipping, and sale. However, the extensive use of packaging materials has resulted in a significant amount of waste, as most packaging is thrown away after use, creating a lot of waste. Many packaging materials are not recyclable because they consist of a mix of different types of plastics, which need to be separated before recycling. However, the process of separating these plastics is often difficult and discourages recycling. Packages are made from multiple materials to serve various purposes. For example, certain packaging may be needed to protect products, including food products from moisture or dirt, block gases like oxygen, or keep liquids, flavors, or aromas inside. In order to achieve these functions, materials like plastics, certain metals, and special barrier layers are combined. However, the combination of these materials further increases the complexity of recycling. As a result, large amounts of packaging waste end up in landfills or incinerators, contributing significantly to environmental pollution.

Packaging waste could be reduced by limiting non-recyclable parts of a package to a small, removable section that can be easily separated, allowing the rest of the package to be recycled. This approach has led to the introduction of special materials, such as liners, which include different layers designed for specific functions like blocking gases and providing strength. Further, after use, the liner can be peeled off from the recyclable container, allowing the recyclable part to be processed while the non-recyclable liner is discarded. However, these liners often face inconsistencies in performance, such as inadequate protection against environmental factors including insufficient gas and moisture barrier properties, challenges in maintaining structural integrity, and difficulty in being easily removed without leaving residues on the recyclable container.

Current solutions to such issues often involve the use of complex multilayer liners designed to meet these diverse requirements. Despite their advanced design, the complex multilayer liners frequently struggle to deliver consistent results, particularly in areas such as gas barrier properties, seal integrity, and ease of removal. Moreover, these complex multilayer liners, when coming into direct contact with food products, can lead to significant issues. For example, traditional Modified Atmosphere Packaging (MAP) containers often allow oxidation of food products before the end of their designated shelf life. This oxidation alters the taste, color, texture, and nutritional profile of the food product, leading to limited shelf life. The problem becomes more severe when handling meat products or products containing meat, as these emit specific gases that further complicate storage. Moreover, the complex multi-layered liner may be difficult to peel off completely from the recyclable container, especially if the bonding between the complex multi-layered liner and the recyclable container is too strong or uneven. This can result in leftover non-recyclable material on the container, reducing the effectiveness of recycling. Current methods often struggle to achieve this balance consistently, leading to either compromised seal integrity or difficult removal experiences for end-users.

Further limitations and disadvantages of conventional and traditional approaches will become apparent to one of skill in the art through comparison of such systems with some aspects of the present disclosure, as set forth in the remainder of the present application with reference to the drawings.

### BRIEF SUMMARY OF THE DISCLOSURE

The present disclosure provides a method for manufacturing a modified atmosphere packaging (MAP) substantially as shown in and/or described in connection with at least one of the figures, as set forth more completely in the claims.

These and other advantages, aspects and novel features of the present disclosure, as well as details of an illustrated embodiment thereof, will be more fully understood from the following description and drawings.

### BRIEF DESCRIPTION OF THE DRAWINGS

Embodiments of the present disclosure will now be described, by way of example only, with reference to the following diagrams wherein:

FIG. 1 is a diagram that illustrates the placement of a lamination mold assembly onto a conveyor assembly for manufacturing a modified atmospheric packaging (MAP) container, in accordance with an embodiment of the present disclosure;

FIG. 2 is a diagram that illustrates a system for positioning of a plurality of molded fiber structures onto a plurality of lamination molds of the lamination mold assembly, in accordance with an embodiment of the present disclosure;

FIG. 3 is a diagram that illustrates a lamination system of laminating a multi-layered peelable liner on a plurality of molded fiber structures, in accordance with an embodiment of the present disclosure;

FIG. 4 is a diagram that illustrates a plurality of laminated molded fiber structures, in accordance with an embodiment of the present disclosure;

FIG. 5 is a diagram that illustrates a system for trimming each of the plurality of laminated molded fiber structures, in accordance with an embodiment of the present disclosure;

FIG. 6 is a diagram that illustrates a plurality of laminated molded fiber structures stacked in a grid pattern, in accordance with an embodiment of the present disclosure;

FIG. 7 is a diagram that illustrates an exploded view of the lamination system for laminating the multi-layered peelable liner on the plurality of molded fiber structures, in accordance with an embodiment of the present disclosure;

FIG. 8 is a diagram that illustrates a heating board from the plurality of heating boards of a heating assembly, in accordance with an embodiment of the present disclosure;

FIG. 9 is a diagram that illustrates a top view of a molded fiber structure from the plurality of molded fiber structures, in accordance with an embodiment of the present disclosure;

FIG. 10 is a diagram that illustrates the stacking and de-stacking of two consecutive molded fiber structures, in accordance with an embodiment of the present disclosure;

FIG. 11 is a diagram illustrating a system for of manufacturing a MAP container, in accordance with an embodiment of the present disclosure;

FIG. 12 is a flowchart that illustrates method of manufacturing the MAP container, in accordance with an embodiment of the present disclosure; and

FIG. 13 is a diagram that illustrates a MAP container having a food product packaged inside, in accordance with an embodiment of the present disclosure.

### DETAILED DESCRIPTION OF THE DISCLOSURE

Certain embodiments of the disclosure may be found in a method of manufacturing a modified atmosphere packaging (MAP) container that combines environmentally sustainable molded fiber structures with a multi-layered peelable liner. The disclosed method addresses the critical challenges in sustainable food packaging by integrating biodegradable molded fiber structures with a nine-layer barrier system that provides optimal food preservation properties. Furthermore, the method incorporates a precise lamination process where the multi-layered peelable liner, comprising sequentially arranged layers of polyethylene (PE), polyamide (PA), and ethylene vinyl alcohol (EVOH), is removably attached to a molded fiber structure. Moreover, the method utilizes controlled heating and vacuum suction to ensure optimal attachment of the multi-layered peelable liner to the molded fiber structure, while maintaining the peelability of the multi-layered peelable liner for eventual recycling.

Conventional methods of manufacturing MAP containers typically rely on direct plastic molding or thermoforming processes that produce single-material containers, which present several limitations, such as inability to incorporate biodegradable materials, lack of precise control over multi-layer formation, and inefficient attachment mechanisms. Such methods of manufacturing the MAP container contribute to environmental concerns due to the reliance on energy-intensive single-material molding techniques and the production of the MAP containers that cannot be effectively separated for recycling. The conventional method also lacks in achieving optimal barrier properties and fails to effectively manage the sequential arrangement of the PE layer, the PA, and the EVOH layer that are essential for creating an optimal moisture and oxygen barrier.

In contrast to conventional manufacturing methods, this method of manufacturing the MAP container enables the production of MAP containers that combine environmental sustainability with high-performance food preservation. The precise control of critical parameters including heating temperature, heat distribution, heating time, and vacuum suction, which ensures consistent quality and performance of the MAP container. Furthermore, the method enables precise control over the formation of the multi-layered peelable liner with specific layer thicknesses and weight percentages of different materials, ensuring optimal barrier properties. As a result, the method of manufacturing the MAP containers achieves an optimal food preservation while maintaining environmental sustainability. The precise control over the method of manufacturing the MAP container ensures the production of the MAP containers with zero pinholes and consistent barrier properties, as verified through quality control measures including oil tests, ethyl alcohol tests, vacuum leakage tests, shelf life study, and similar tests.

In the following description, reference is made to the accompanying drawings, which form a part hereof, and which are shown, by way of illustration, various embodiments of the present disclosure.

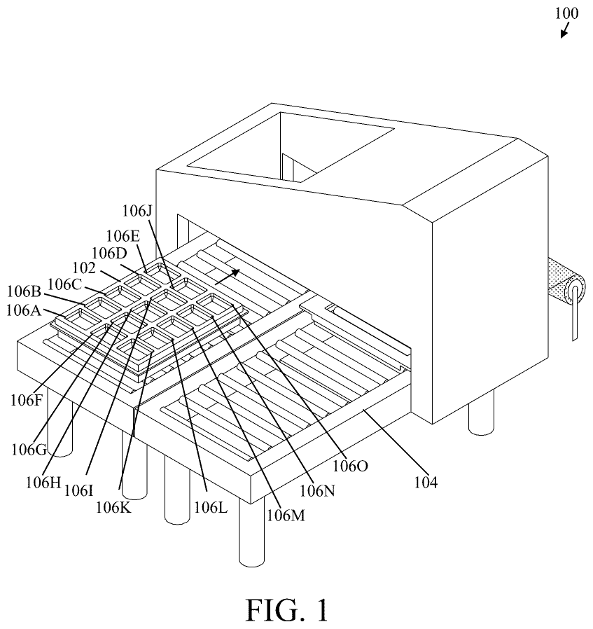

FIG. 1 is a diagram that illustrates the placement of a lamination mold assembly onto a conveyor assembly for manufacturing a modified atmospheric packaging (MAP) container, in accordance with an embodiment of the present disclosure. With reference to FIG. 1, there is shown a diagram 100 that illustrates the lamination mold assembly 102 placed on the conveyor assembly 104.

In an exemplary scenario, the lamination mold assembly 102 refers to an assembly (or a platform) that includes a plurality of lamination molds (i.e., a first lamination mold 106A, a second lamination mold 106B, a third lamination mold 106C, a fourth lamination mold 106D, a fifth lamination mold 106E, a sixth lamination mold 106F, a seventh lamination mold 106G, an eight lamination mold 106H, a ninth lamination mold 106I, a tenth lamination mold 106J, an eleventh lamination mold 106K, a twelfth lamination mold 106L, a thirteenth lamination mold 106M, a fourteenth lamination mold 106N, a fifteenth lamination mold 1060) configured to hold a plurality of molded fiber structures. In an implementation, the plurality of lamination molds is formed on the lamination mold assembly 102 in a grid pattern, wherein each of the lamination molds from the plurality of lamination molds matches the contours and dimensions of the molded fiber structure 902 thereby ensuring a precise alignment and consistent application of the multi-layered peelable liner. In an implementation, the grid pattern of the plurality of lamination molds can be configured in a 3×2 or 3×3 or 3×4 or 3×5 matrix pattern without affecting the scope of the scope of the disclosure, thereby allowing concurrent processing of the plurality of molded fiber structures respectively.

The conveyor assembly 104 refers to an assembly for mechanical transport of the lamination mold assembly that is configured to transport the lamination mold assembly through multiple stations, including a first site where the plurality of molded fiber structures are placed onto the plurality of lamination molds formed on the lamination mold assembly, a second site where the multi-layered peelable liner is aligned with the plurality of molded fiber structures using a jig and attached through controlled heating and vacuum suction, and a third site (i.e., a trimming site) where the excess portion of the multi-layered peelable liner is trimmed to segregate individual MAP containers.

In operation, the lamination mold assembly 102 is placed onto the conveyor assembly 104 such that the plurality of lamination molds of the lamination mold assembly 102 can align with a plurality of heating boards of a heating assembly and the multi-layered peelable liner during the lamination process, which enables proper lamination of the multi-layered peelable liner with the plurality of molded fiber structures that are placed on the plurality of lamination molds of the lamination mold assembly 102. In an implementation, the lamination mold assembly 102 features various guiding features, including alignment pins, guide rails, positioning grooves, and locking mechanisms that mate with corresponding alignment features on the conveyor assembly 104 to secure the lamination mold assembly 102 on the conveyor assembly 104.

Thus, the lamination mold assembly 102 maintains proper alignment and stability during transport between different sites, specifically from the first site where the plurality of molded fiber structures are placed onto the plurality of lamination molds formed on the lamination mold assembly to the second site where the multi-layered peelable liner is aligned with the plurality of molded fiber structures using the jig and attached through controlled heating and vacuum suction, and finally to the third site (i.e., a trimming site) where the excess portion of the multi-layered peelable liner is trimmed to segregate individual MAP containers.

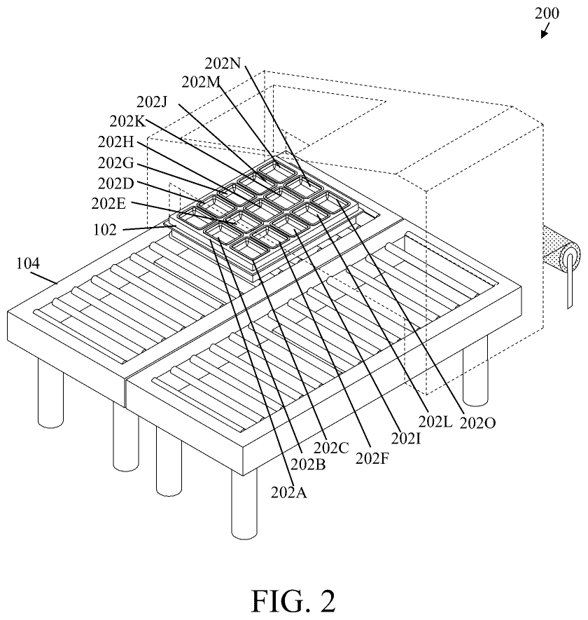

FIG. 2 is a diagram that illustrates a system for positioning of a plurality of molded fiber structures onto a plurality of lamination molds of the lamination mold assembly, in accordance with an embodiment of the present disclosure. FIG. 2 is described in conjunction with the FIG. 1. With reference to FIG. 2, there is shown the system 202 placement on the plurality of molded fiber structures (i.e., a first molded fiber structure 204A, a second molded fiber structure 204B, a third molded fiber structure 204C, a fourth molded fiber structure 204D, a fifth molded fiber structure 204E, a sixth molded fiber structure 204F, a seventh molded fiber structure 204G, an eight molded fiber structure 204H, a ninth molded fiber structure 204I, a tenth molded fiber structure 204J, an eleventh molded fiber structure 204K, a twelfth molded fiber structure 204L, a thirteenth molded fiber structure 204M, a fourteenth molded fiber structure 204N, a fifteenth molded fiber structure 204O) onto the plurality of the lamination molds of the lamination mold assembly 102.

In an exemplary scenario, each of the plurality of molded fiber structures refers to a base of the MAP container, which can be molded in various structures, such as triangular, rectangular, square, oval, round, polygonal, and the like without affecting the scope of the present disclosure. Moreover, each of the plurality of molded fiber structures includes a first surface that corresponds to the product contact surface and a second surface, opposite to the first surface. Furthermore, each of the plurality of molded fiber structures of the MAP container 1300 includes a set of perforations distributed across the molded fiber structure 902 that are configured to provide a pathway for evacuation of the air present between the multi-layered peelable liner and the first surface of the molded fiber structure when the multi-layered peelable liner 302 is removably attached to the first surface of the molded fiber structure. In another implementation, the first surface may be textured or patterned to ensure stability and reduce the potential movement of the food product within the MAP container, which could otherwise result in bruising or contamination.

Each of the pluralities of molded fiber structures is made through a molding process utilizing a slurry comprising a biodegradable fibrous product and water. The biodegradable fibrous product used in the slurry may comprise one or more of: agro-pulp, recycled paper or cardboard, plant-based biodegradable fibers, wood-based biodegradable fibers, or a combination thereof. In an example, the recycled cardboard and water are mixed in a pulping machine to prepare a uniform fiber slurry by initially shredding the recycled cardboard into small pieces and then mixing the shredded recycled cardboard with water. In another example, the agro-pulp derived from sugarcane bagasse is processed into the slurry by first cleaning the bagasse to remove residual sugars and debris, then mechanically refining the bagasse into bagasse fibers, and finally mixing the bagasse fibers with water to achieve the desired consistency for molding. In yet another example, the wood-based biodegradable fibers, such as those derived from softwood pulp, are processed through mechanical and thermal treatments before being mixed with water to form the slurry. Furthermore, the prepared slurry is then transferred to a molding station where the prepared slurry is poured into molds having the desired shape of the MAP container. The molds include perforations that allows water drainage during the molding process. Moreover, the excess water is removed from the slurry through the application of heat and pressure to the molds, which compresses and forms the prepared slurry into the desired structure while simultaneously drying the structure to form the molded fiber structure.

In operation, the plurality of molded fiber structures (i.e., the first molded fiber structure 204A, the second molded fiber structure 204B, the third molded fiber structure 204C, the fourth molded fiber structure 204D, the fifth molded fiber structure 204E, the sixth molded fiber structure 204F, the seventh molded fiber structure 204G, the eight molded fiber structure 204H, the ninth molded fiber structure 204I, the tenth molded fiber structure 204J, the eleventh molded fiber structure 204K, the twelfth molded fiber structure 204L, the thirteenth molded fiber structure 204M, the fourteenth molded fiber structure 204N, the fifteenth molded fiber structure 204O) are positioned onto the plurality of lamination molds (i.e., the first lamination mold 106A, the second lamination mold 106B, the third lamination mold 106C, the fourth lamination mold 106D, the fifth lamination mold 106E, the sixth lamination mold 106F, the seventh lamination mold 106G, the eight lamination mold 106H, the ninth lamination mold 106I, the tenth lamination mold 106J, the eleventh lamination mold 106K, the twelfth lamination mold 106L, the thirteenth lamination mold 106M, the fourteenth lamination mold 106N, the fifteenth lamination mold 106O) of the lamination mold assembly 102 through an automated process that involves the inclusion of robotic arms equipped with precision grippers. The robotic arms are configured to pick each of the plurality of molded fiber structures and position them onto the corresponding lamination mold from the plurality of lamination, thereby ensuring that each of the plurality of molded fiber structures is properly positioned on the corresponding lamination mold with the first surface of each of the plurality of molded fiber structures (i.e., the product contact surface) facing upward to receive the multi-layered peelable liner. In an implementation, the placement of the plurality of molded fiber structures onto the plurality of lamination molds is done manually, wherein an operator positions each of the plurality of molded fiber structure onto the corresponding lamination mold from the plurality of lamination molds following a predetermined sequence, thereby ensuring that each of the plurality of molded fiber structures positioned is properly seated and aligned within the corresponding lamination mold.

Thus, the positioning of the plurality of molded fiber structures onto the plurality of lamination molds of the lamination mold assembly 102 ensures proper alignment and positioning of each molded fiber structure for the subsequent lamination process. The positioning, whether done through automated means using robotic arms with precision grippers or manually by an operator following a predetermined sequence is configured to maintain consistent quality in the manufacturing of MAP containers without any defect. Furthermore, the proper positioning of the plurality of molded fiber structures onto the plurality of lamination molds of the lamination mold assembly 102 ensures that the first surface of each molded fiber structure faces upward and aligns with the multi-layered peelable liner, while the set of perforations across each molded fiber structure align with the corresponding vacuum channels in the lamination molds.

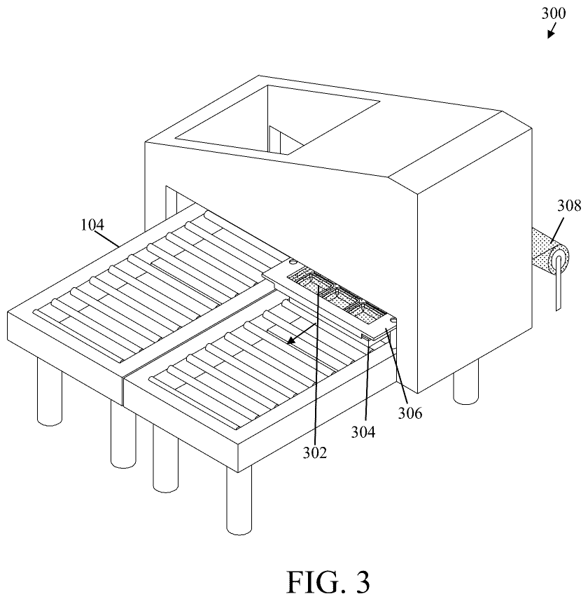

FIG. 3 is a diagram that illustrates a lamination system of laminating a multi- layered peelable liner on a plurality of molded fiber structures, in accordance with an embodiment of the present disclosure. FIG. 3 is described in conjunction with the FIGS. 1 and 2. With reference to FIG. 3, there is shown the lamination system 300 of laminating (or removably attaching) the multi-layered peelable liner 302 on the plurality of molded fiber structures. The plurality of molded fiber structures is placed on the plurality of lamination molds of the lamination mold assembly 102. Moreover, the lamination mold assembly is further placed on a vacuum suction assembly 304. The lamination system 300 of laminating the multi-layered peelable liner 302 on the plurality of molded fiber structures includes a heating assembly.

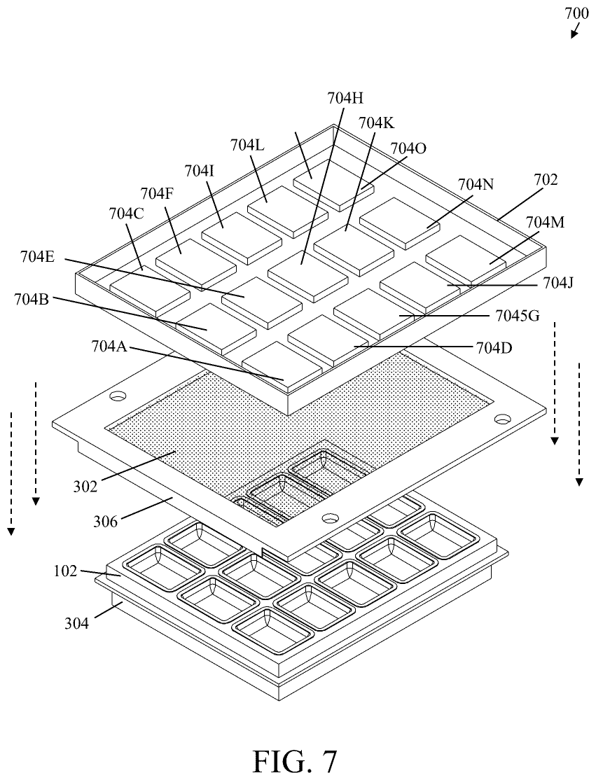

In an exemplary scenario, the lamination system 300 is utilized for laminating the multi-layered peelable liner 302 on the plurality of molded fiber structures. The lamination system 300 includes the vacuum suction assembly 304, a movable jig 306, a liner roll 308, and the heating assembly (as described in FIG. 7). The lamination system 300 is configured to perform controlled lamination of the multi-layered peelable liner 302 onto the plurality of molded fiber structures through a coordinated operation of the different components of the lamination system 300.

The multi-layered peelable liner 302 refers to a protective layer that is configured to provide optimal barrier properties for food preservation in the MAP container. The multi-layered peelable liner 302 is laminated on the first surface of each of the plurality of molded fiber structures. The multi-layered peelable liner 302 includes a plurality of polyethylene (PE) layers, a plurality of polyamide (PA) layers, and an Ethylene Vinyl Alcohol (EVOH) layer. In an implementation, the multi-layered peelable liner 302 is made through co-extrusion of a defined number of layers of polyethylene (PE), polyamide (PA), and Ethylene Vinyl Alcohol (EVOH). Initially, the raw materials, including polyethylene (PE), polyamide (PA), ethylene vinyl alcohol (EVOH), and adhesive polymers (used to form the tie layer, such as maleic anhydride-modified polyethylene, ethylene vinyl acetate (EVA), or functionalized polyolefins), are prepared in the form of pellets or granules. Each of the raw materials is fed into separate compartments of an extruder, where the raw materials are heated to the respective melting points and homogenized into a viscous or molten state. The molten raw materials are then pushed through individual channels within a multi-manifold die. The multi-manifold die combines the molten layers of the different raw materials into a single, multi-layered structure by arranging the layers in a predefined sequential configuration (e.g., a first PE layer/a second PE layer/a first intermediate tie layer/a first PA layer/an EVOH layer/a second PA layer/a second intermediate tie layer/a third PE layer/a fourth PE layer). The multi-manifold die controls the thickness and distribution of each layer, ensuring uniform performance and quality. After the different layers are combined in the die, the multi-layered structure is extruded as a single sheet. The extruded sheet is then cooled and solidified, forming the multi-layered peelable liner 302.

The heating assembly refers to an assembly of a plurality of heating boards configured to provide controlled heat during the process of attaching the multi-layered peelable liner 302 to the plurality of molded fiber structures. Each of the plurality of heating boards of the heating assembly further includes a plurality of heating elements that are arranged, for example, in a grid pattern (e.g., a 9×9 grid pattern). The plurality of heating elements is configured to operate at precisely regulated temperatures that range between 600 degrees Celsius to 800 degrees Celsius to activate the adhesive properties of the different materials (or layers) of the multi-layered peelable liner 302, such as polyethylene (PE), enabling a strong and consistent bond with the molded fiber structure. In an implementation, each heating board of the heating assembly is configured to heat the multi-layered peelable liner 302 for a single molded fiber structure where the plurality of heating elements is distributed across each heating board. Further, each heating board with the plurality of heating elements are distributed and operated with different temperatures in different zones like corner zones, a central zone, peripheral zones.

The movable jig 306 refers to a mechanical component, such as a frame that is configured to hold and transport the multi-layered peelable liner 302 from the liner roll 308 to a position above the lamination mold assembly 102. The movable jig 306 is configured to maintain proper tension and alignment of the multi-layered peelable liner 302 during the movement and positioning of the movable jig 306. Furthermore, the movable jig 306 is controlled to move downward towards the lamination mold assembly 102 once the multi-layered peelable liner 302 is heated to the required temperature by the heating assembly, ensuring precise positioning of the heated multi-layered peelable liner 302 over the plurality of molded fiber structures for the lamination process.

In operation, the lamination system 300 is configured to perform a coordinated sequence of steps to attach the multi-layered peelable liner 302 to the plurality of molded fibers. Initially, the plurality of molded fiber structures is positioned on the lamination mold assembly 102, which is placed above the vacuum suction assembly 304. The movable jig 306 retrieves a section of the multi-layered peelable liner 302 from the liner roll 308 and positions the multi-layered peelable liner 302 above the lamination mold assembly 102 while maintaining proper tension and alignment. The heating assembly, comprising the plurality heating boards with plurality of heating elements arranged in a grid pattern, activates to heat the positioned multi-layered peelable liner 302. The plurality of heating elements operates at controlled temperatures between 600 degrees Celsius to 800 degrees Celsius, with different temperature zones across the plurality of heating boards to ensure optimal heat distribution. After heating the multi-layered peelable liner 302 for 6 seconds to 12 seconds, the movable jig 306 descends, precisely positioning the heated multi-layered peelable liner 302 onto the plurality of molded fiber structures. Simultaneously, the vacuum suction assembly 304 applies vacuum pressure through the set of perforations in the molded fiber structures for 5 seconds to 20 seconds, ensuring uniform adhesion of the heated multi-layered peelable liner 302 to the surface of each molded fiber structure. The heating continues during the vacuum suction process until proper adhesion is achieved. Thus, the coordinated operation ensures consistent lamination across the plurality of molded fiber structures while maintaining the peelability of the multi-layered peelable liner 302.

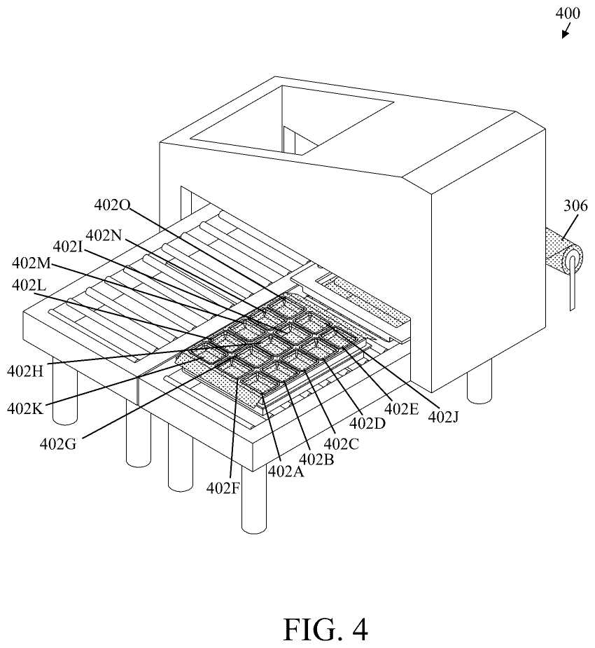

FIG. 4 is a diagram that illustrates a plurality of laminated molded fiber structures, in accordance with an embodiment of the present disclosure. FIG. 4 is described in conjunction with the FIGS. 1 to 3. With reference to FIG. 4, there is shown the plurality of laminated molded fiber structures (i.e., a first laminated molded fiber structure 402A, a second laminated molded fiber structure 402B, a third laminated molded fiber structure 402C, a fourth laminated molded fiber structure 402D, a fifth laminated molded fiber structure 402E, a sixth laminated molded fiber structure 402F, a seventh laminated molded fiber structure 402G, an eight laminated molded fiber structure 402H, a ninth laminated molded fiber structure 402I, a tenth laminated molded fiber structure 402J, an eleventh laminated molded fiber structure 402K, a twelfth laminated molded fiber structure 402L, a thirteenth laminated molded fiber structure 402M, a fourteenth laminated molded fiber structure 402N, and a fifteenth laminated molded fiber structure 402O).

In an exemplary scenario, the plurality of laminated molded fiber structures (i.e., the first laminated molded fiber structure 402A, the second laminated molded fiber structure 402B, the third laminated molded fiber structure 402C, the fourth laminated molded fiber structure 402D, the fifth laminated molded fiber structure 402E, the sixth laminated molded fiber structure 402F, the seventh laminated molded fiber structure 402G, the eight laminated molded fiber structure 402H, the ninth laminated molded fiber structure 4021, the tenth laminated molded fiber structure 402J, the eleventh laminated molded fiber structure 402K, the twelfth laminated molded fiber structure 402L, the thirteenth laminated molded fiber structure 402M, the fourteenth laminated molded fiber structure 402N, and the fifteenth laminated molded fiber structure 402O) refers to a group of molded fiber containers, each having the multi-layered peelable liner laminated onto the respective first surface. Each laminated molded fiber structure from the plurality of laminated molded fiber structure is arranged in a grid configuration on the lamination mold assembly, enabling simultaneous processing of the plurality of laminated molded fiber structures. The plurality of laminated molded fiber structures is formed through the coordinated operation of the heating assembly and the vacuum suction assembly 304, where the multi-layered peelable liner 302 is heated to temperatures between 600 degrees Celsius to 800 degrees Celsius and vacuum-sealed onto each molded fiber structure of the plurality of molded fiber structure. The grid arrangement of the plurality of molded fiber structures optimizes manufacturing efficiency while ensuring uniform lamination of the multi-layered peelable liner 302 across the plurality of molded fiber structures. Each of the plurality of molded fiber structures maintains an individual characteristic with the multi-layered peelable liner 302, conforming to the contours of the first surface through the vacuum suction. The arrangement allows for systematic heat distribution through the heating assembly's 9×9 grid pattern of the plurality of heating elements, ensuring consistent adhesion properties across the plurality of molded fiber structures while maintaining the peelability of the multi-layered peelable liner 302.

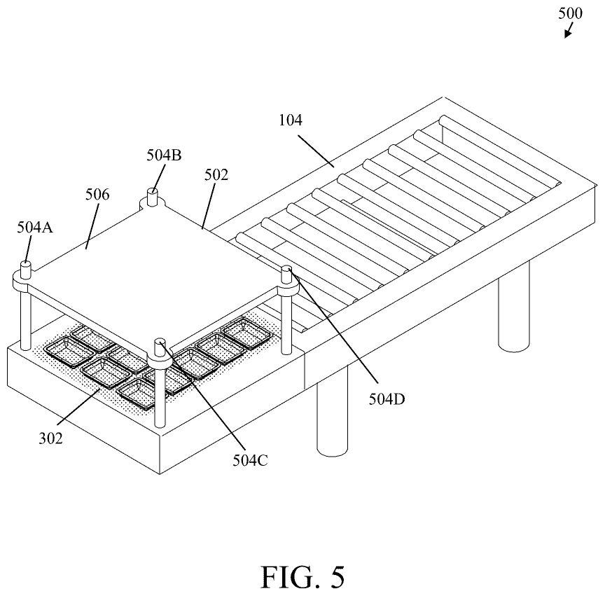

FIG. 5 is a diagram that illustrates a system for trimming each of a plurality of laminated molded fiber structures, in accordance with an embodiment of the present disclosure. FIG. 5 is described in conjunction with the FIGS. 1 to 4. With reference to FIG. 5, there is shown the system 500 for trimming each of the plurality of laminated molded fiber structures. The system 500 includes a trimming assembly 502 configured to trim the excess portion of the multi-layered peelable liner 302 from each of the plurality of laminated molded fiber structures in order to separate each of the plurality of laminated molded fiber structures.

In an exemplary scenario, the trimming assembly 502 is configured to separate each of the plurality of laminated molded fiber structures by removing excess multi-layered peelable liner. The trimming assembly 502 consists of a plurality of vertical supports (i.e., a first vertical support 504A, a second vertical support 504B, a third vertical support 504C, a fourth vertical support 504D) positioned at the corners of a frame 506, which provides stability and precise alignment during the trimming operation. The trimming assembly 502 is positioned adjacent to the lamination mold assembly 102, enabling a continuous manufacturing process flow. In an implementation, the trimming assembly 502 comprises a plurality of cutting surfaces formed within the frame 506 that are precisely aligned with the boundaries of each of the plurality of laminated molded fiber structure. Each of the plurality of cutting surfaces features sharpened edges arranged in a pattern matching the perimeter of the each of the laminated molded fiber structures. The plurality of cutting surfaces is positioned to simultaneously contact and trim the excess multi-layered peelable liner 302 along predetermined cut lines surrounding each of the plurality of laminated molded fiber structures.

In operation, after the lamination, the plurality of laminated molded fiber structures, still connected by the continuous sheet of the multi-layered peelable liner 302, are transferred to a trimming station. At the trimming station, the lamination mold assembly 102 with the plurality of laminated molded fiber structures is precisely positioned beneath the trimming assembly 502, utilizing the plurality of vertical supports for alignment guidance. The frame 506 of the trimming assembly 502 descends, bringing the plurality of cutting surfaces into contact with the excess multi-layered peelable liner 302 surrounding each of the plurality of laminated molded fiber structures. The cutting surfaces apply uniform pressure along the predetermined cut lines, simultaneously trimming the excess material from all laminated molded fiber structures. The concurrent trimming operation ensures consistent separation of each of the laminated molded fiber structures while maintaining the integrity of the bond between the multi-layered peelable liner 302 and each of the plurality of laminated molded fiber structure. The trimmed residue of the multi-layered peelable liner 302 is then removed, leaving precisely separated laminated molded fiber structures ready for subsequent processing or packaging. Thus, the automated trimming process maintains manufacturing efficiency while ensuring uniform quality across all the separated laminated molded fiber structures.

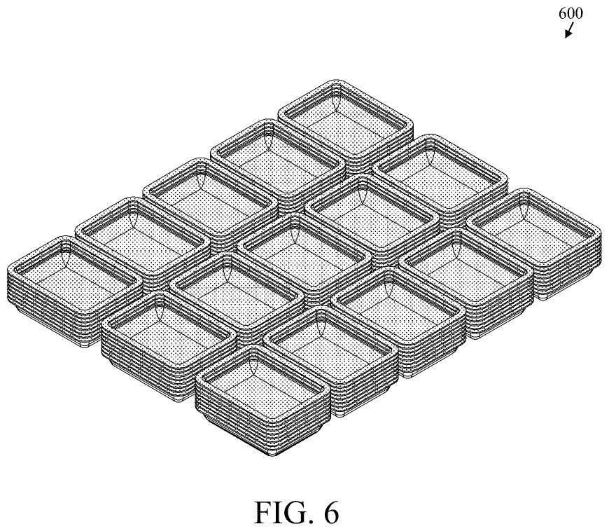

FIG. 6 is a diagram that illustrates a plurality of laminated molded fiber structures stacked in a grid pattern, in accordance with an embodiment of the present disclosure. FIG. 6 is described in conjunction with the FIGS. 1 to 5. With reference to FIG. 6, there is shown the diagram 600 that illustrates the plurality of laminated molded fiber structures stacked in a grid pattern.

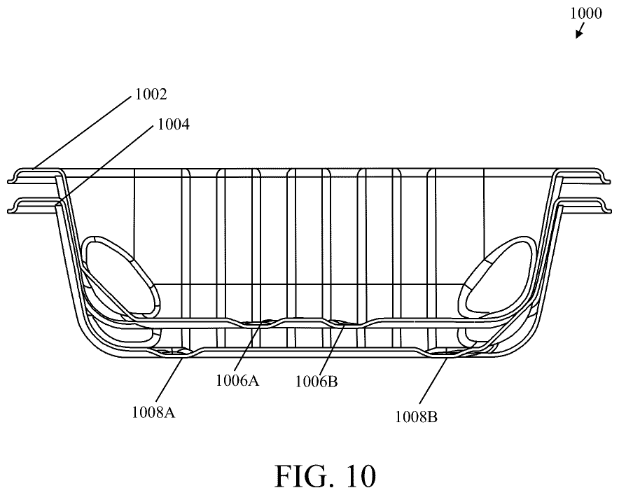

In an exemplary scenario, the diagram 600 illustrates a systematic arrangement of the plurality of separated laminated molded fiber structures stacked in a predefined pattern (as shown in the FIG. 10) following the trimming process. In an implementation, the plurality of separated laminated molded fiber structures is organized in a 3×5 grid pattern, maintaining the same configuration as the plurality of molded fiber structures had during the lamination and trimming processes. Each individual laminated molded fiber structure appears to be a distinct unit, having been successfully separated from the continuous sheet of multi-layered peelable liner 302 through the trimming process. Each of the plurality of separated laminated molded fiber structures in the grid exhibit identical dimensional characteristics, demonstrating the consistency achieved through the manufacturing process. The surface of each of the plurality of separated laminated molded fiber structures shows the precisely laminated multi-layered peelable liner, indicated by the textured pattern visible across the plurality of separated laminated molded fiber structures.

FIG. 7 is a diagram that illustrates an exploded view of the lamination system for laminating the multi-layered peelable liner on the plurality of molded fiber structures, in accordance with an embodiment of the present disclosure. FIG. 7 is described in conjunction with the FIGS. 1 to 6. With reference to FIG. 7, there is shown the exploded view 700 of the lamination system 300 for laminating the multi-layered peelable liner 302 on the plurality of molded fiber structures. The lamination system includes a heating assembly 702, the vacuum suction assembly 304, and the multi-layered peelable liner 302 in the movable jig 306.

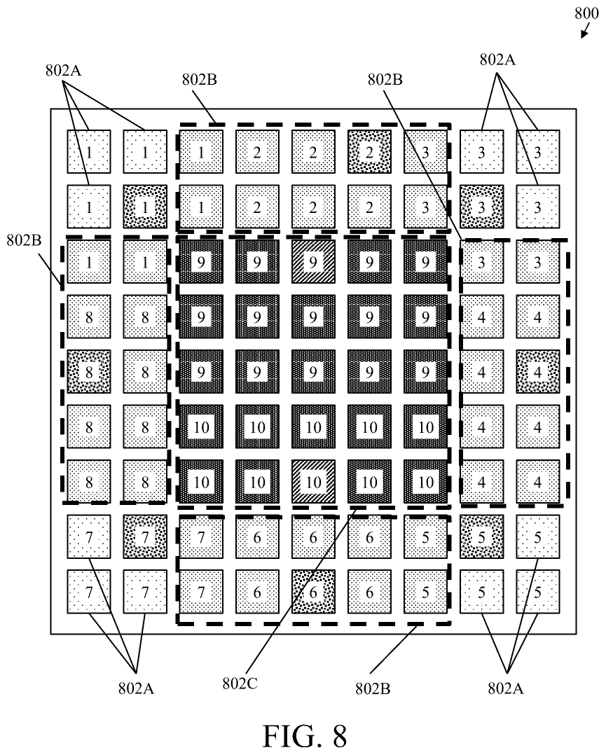

The heating assembly 702 refers to an assembly of a plurality of heating boards (i.e., a first heating board 704A, a second heating board 704B, a third heating board 704C, a fourth heating board 704D, a fifth heating board 704E, a sixth heating board 704F, a seventh heating board 704G, an eight heating board 704H, a ninth heating board 704I, a tenth heating board 704J, an eleventh heating board 704K, a twelfth heating board 704L, a thirteenth heating board 704M, a fourteenth heating board 704N, and a fifteenth heating board 704O) configured to provide controlled heat during the process of attaching the multi-layered peelable liner 302 to the plurality of molded fiber structures. Each of the plurality of heating boards of the heating assembly 702 further includes a plurality of heating elements (as shown in the FIG. 8) that are arranged, for example, in a grid pattern (e.g., a 9×9 grid pattern). The plurality of heating elements is configured to operate at precisely regulated temperatures that range between 600 degrees Celsius to 800 degrees Celsius to activate the adhesive properties of the different materials (or layers) of the multi-layered peelable liner 302, such as polyethylene (PE), enabling a strong and consistent bond with the molded fiber structure 902. In an implementation, each heating board of the heating assembly is configured to heat the multi-layered peelable liner 302 for a single molded fiber structure where the plurality of heating elements is distributed across each heating board. Further, each heating board with the plurality of heating elements are distributed and operated with different temperatures in different zones like corner zones, a central zone, peripheral zones.

In operation, the lamination system 300 is configured to perform a coordinated sequence of steps to attach the multi-layered peelable liner 302 to the plurality of molded fibers. Initially, the plurality of molded fiber structures is positioned on the lamination mold assembly 102, which is placed above the vacuum suction assembly 304. The movable jig 306 retrieves a section of the multi-layered peelable liner 302 from the liner roll 308 and positions the multi-layered peelable liner 302 above the lamination mold assembly 102 while maintaining proper tension and alignment. The heating assembly, comprising the plurality heating boards with plurality of heating elements arranged in a grid pattern, activates to heat the positioned multi-layered peelable liner 302. The plurality of heating elements operates at controlled temperatures between 600 degrees Celsius to 800 degrees Celsius, with different temperature zones across the plurality of heating boards to ensure optimal heat distribution. After heating the multi-layered peelable liner 302 for 6 seconds to 12 seconds, the movable jig 306 descends, precisely positioning the heated multi-layered peelable liner 302 onto the plurality of molded fiber structures. Simultaneously, the vacuum suction assembly 304 applies vacuum pressure through the set of perforations in the molded fiber structures for 5 seconds to 20 seconds, ensuring uniform adhesion of the heated multi-layered peelable liner 302 to the surface of each molded fiber structure. The heating continues during the vacuum suction process until proper adhesion is achieved. Thus, the coordinated operation ensures consistent lamination across the plurality of molded fiber structures while maintaining the peelability of the multi-layered peelable liner 302.

FIG. 8 is a diagram that illustrates a heating board from the plurality of heating boards of a heating assembly, in accordance with an embodiment of the present disclosure. FIG. 8 is described in conjunction with the FIGS. 1 to 7. With reference to FIG. 8, there is shown the heating board 800. The heating board 800 comprises the plurality of heating element arranged, for example, in a 9×9 grid pattern.

In an exemplary scenario, the heating board (e.g., a first heating board 704A) comprises the plurality of heating elements arranged in different groups, wherein the temperature of each heating element of the plurality of heating elements is adjusted independently, such that different areas of the multi-layered peelable liner 302 are heated with different temperatures. The first group of plurality of heating elements 802A are placed along the peripheral region of the heating board 800 and provides heat to the edges of the multi-layered peelable liner 302. The second group of heating elements 802B are placed in the intermediate region of the heating board 800, surrounding the central portion of the heating board 800, and provides heat to the areas closer to the middle of the multi-layered peelable liner 302. The third group of plurality of heating elements are placed at the central region of the heating board 800, directly beneath the core portion of the multi-layered peelable liner 302 and are configured to apply intense and concentrated heat to ensure that the central portion of the multi-layered peelable liner 302 adheres firmly to the first surface of the molded fiber structure 902. In an example, the first group of plurality of heating elements are configured to maintain a temperature that ranges from 600° C. to 650° C. to prevent overheating of the edges of the multi-layered peelable liner 302, while maintaining sufficient heat for proper adhesion. Similarly, the second group of plurality of heating elements 802B are configured to maintain a temperature that ranges from 650° C. to 700° C. and the third group of plurality of heating elements 802C are configured to maintain the temperature that ranges from 700° C. to 800° C. that ensures a precise conforming of the multi-layered peelable liner 302 to the first surface of the plurality of molded fiber structures without creating weak points or compromising the seal integrity of the multi-layered peelable liner 302. Furthermore, there exist some individual heating elements that are described with densely dotted patterns (as depicted in in FIG. 8), which are configured to apply a different heating temperature to specific areas of the multi-layered peelable liner 302. For example, an individual heating element is configured to provide a high temperature of 750° C. to a specific area of the peelable liner 302 that is going to be conformed to a raised part of the molded fiber structure, such that the heat softens multi-layered peelable liner 302 adequately to conform to the contours of the raised part without causing wrinkling, tearing, or uneven adhesion. In another example, another heating element is configured to provide a moderate temperature of 650° C. to an edge of the multi-layered peelable liner 302, ensuring precise adhesion of the multi-layered peelable liner 302 along a peripheral part of the plurality of molded fiber structures without overheating or causing the multi-layered peelable liner 302 to become brittle at the peripheral part of the plurality of molded fiber structures.

In an implementation, the heating board 800 includes an independent temperature control of each of the plurality of heating elements that enables a precise heat management during the attachment process of the multi-layered peelable liner 302 to the plurality of molded fiber structures while preventing any damage to the material of the multi-layered peelable liner 302. The heating board 800 incorporates ten distinct temperature control zones that can be independently regulated to achieve optimal heat distribution across the entire surface of the multi-layered peelable liner 302, wherein temperature control zone incorporates independent temperature sensors and control mechanisms, enabling real-time monitoring and adjustment of heating parameters. Advantageously, the independent temperature control of each of the plurality of heating elements enables a precise heat management during the attachment process of the multi-layered peelable liner 302 to the plurality of molded fiber structures while preventing any damage to the material of the multi-layered peelable liner 302.

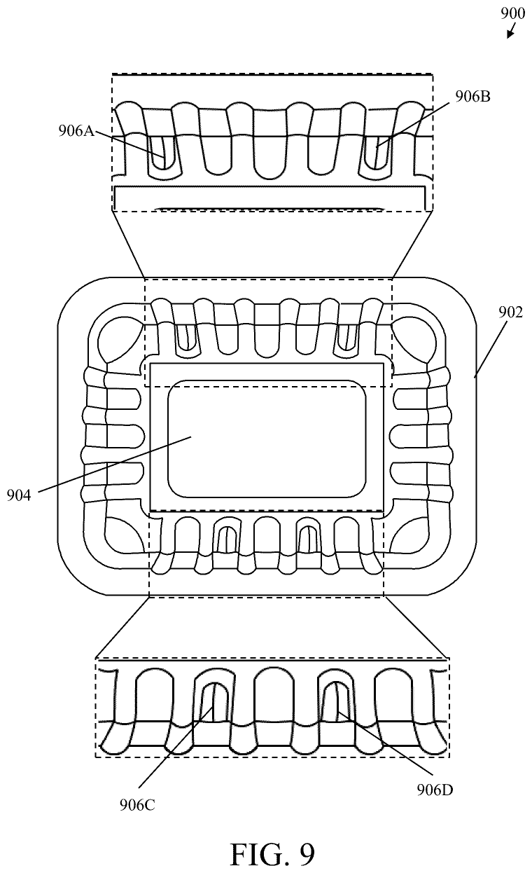

FIG. 9 is a diagram that illustrates a top view of a molded fiber structure from the plurality of molded fiber structures, in accordance with an embodiment of the present disclosure. FIG. 9 is described in conjunction with the FIGS. 1 to 8. With reference to FIG. 9, there is shown the top view 900 of the molded fiber structure 902. The molded fiber structure 902 comprises the first surface 904 that corresponds to the product contact surface, and a plurality of de-nesting lugs (i.e., a first de-nesting lug 906A, a second de-nesting lug 906B, a third de-nesting lug 906C, and a fourth de-nesting lug 906D).

The first surface 904 is configured to interface with the contents, such as food products packed inside a MAP container. The first surface 904 includes by a recessed central region forming a cavity for product containment, surrounded by a raised peripheral rim. The surface topology of the molded fiber structure 902 is configured to provide optimal contact area for the multi-layered peelable liner 302 attachment while maintaining structural integrity for food product containment. Moreover, the first surface 904 incorporates a smooth finish achieved through the molding process to ensure uniform adhesion of the multi-layered peelable liner 302.

The plurality of de-nesting lugs (i.e., the first de-nesting lug 906A, the second de-nesting lug 906B, the third de-nesting lug 906C, and the fourth de-nesting lug 906D) are structural protrusions featuring a tapered profile that extends outward from the first surface 904 of the molded fiber structure 902, where two de-nesting lugs of the plurality of de-nesting lugs are positioned at the adjacent sides of the molded fiber structure 902. Each de-nesting lug from the plurality of de-nesting lugs is positioned at a precise angle relative to the walls of the molded fiber structure 902 to optimize the functionality of the plurality of de-nesting lugs. The plurality of de-nesting lugs incorporates a curved outer surface that facilitates smooth separation while maintaining structural integrity during the stacking and de-stacking processes.

The adjacent arrangement of two de-nesting lugs (i.e., the first de-nesting lug 906A and the second de-nesting lug 906B) and the other two de-nesting lugs (i.e., the third de-nesting lug 906C and the fourth de-nesting lug 906D) avoids two molded fiber structures becoming tightly nested when stacked. In an implementation, the two consecutive molded fiber structures in a stack are rotated 180 degrees relative to each other. When two molded fiber structures are stacked with this 180-degree rotation, the first de-nesting lug 906A and second de-nesting lug 906B of the upper structure align with the open spaces between the third de-nesting lug 906C and fourth de-nesting lug 906D of the lower structure, which creates mechanical interference points that maintain precise spacing between stacked containers.

FIG. 10 is a diagram that illustrates the stacking and de-stacking of two consecutive molded fiber structures, in accordance with an embodiment of the present disclosure. FIG. 10 is described in conjunction with the FIGS. 1 to 9. With reference to FIG. 10, there is shown the stacking and de-stacking of two consecutive molded fiber structures (i.e., a first molded fiber structure 1002, and a second molded fiber structure 1004). The first molded fiber structure 1002 includes a plurality of de-nesting lugs, including a first de-nesting lug 1006A and a second de-nesting lug 1006B. The second molded fiber structure 1004 includes a plurality of de-nesting lugs, including a first de-nesting lug 1008A and a second de-nesting lug 1008B.

In operation, when the first molded fiber structure 1002 is positioned above the second molded fiber structure 1004 with a 180-degree rotation, the plurality of de-nesting lugs of the first molded fiber structure 1002 and the second molded fiber structure 1004 creates specific interaction points to maintain separation. The first de-nesting lug 1006A of the first molded fiber structure 1002 aligns with the space between the first de-nesting lug 1008A and second de-nesting lug 1008B of the second molded fiber structure 1004. Similarly, the second de-nesting lug 1006B aligns with the opposite space between the first de-nesting lug 1008A and second de-nesting lug 1008B of the second molded fiber structure 1004. Such an alternating arrangement prevents complete nesting between the first molded fiber structure 1002 and the second molded fiber structure 1004 by creating mechanical interference points that maintain a predetermined minimum separation distance between the first molded fiber structure 1002 and the second molded fiber structure 1004. Moreover, the tapered profile of the plurality of de-nesting lugs of both the molded fiber structures facilitate smooth engagement during stacking and clean separation during de-stacking operations. Additionally, the protruded geometry of the plurality of de-nesting lugs of both molded fiber structures ensures that when lifted vertically, the first molded fiber structure 1002 smoothly disengages from the second molded fiber structure 1004 without binding or creating a vacuum effect.

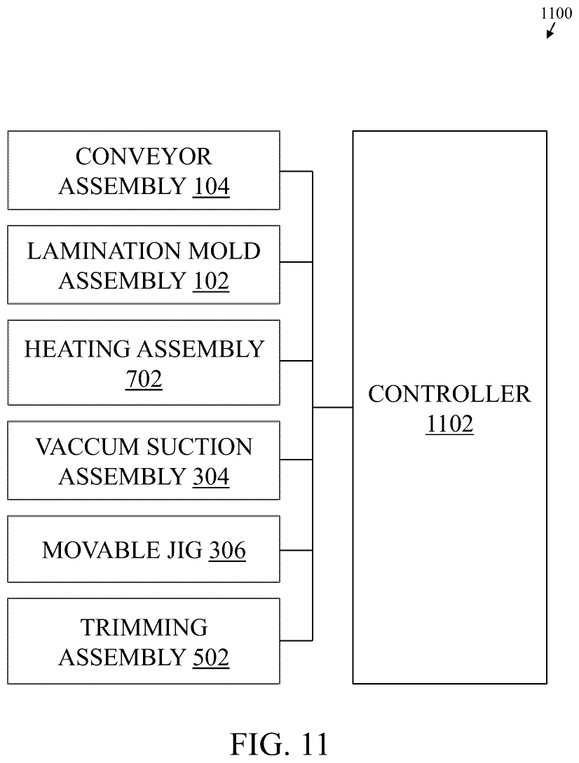

FIG. 11 is a diagram illustrating a system for of manufacturing a MAP container, in accordance with an embodiment of the present disclosure. FIG. 11 is described in conjunction with the FIGS. 1 to 10. The system 1100 for manufacturing the MAP container includes a controller 1102, which is connected with the conveyor assembly 104, the lamination mold assembly 102, the heating assembly 702, the vacuum suction assembly 304, the movable jig 306, and the trimming assembly 502.

In an exemplary scenario, the controller 1102 is configured to coordinate and manage the sequential operation of different components of the system 1100 for manufacturing the MAP container through a centralized control architecture. The controller establishes real-time communication links with different components of the system 1100 to monitor and regulate the functions of different components of the system 1100. In an implementation, the controller is connected with other components of the system through a wireless communication network, such as Bluetooth, Wi-Fi, ZigBee, or other industrial wireless protocols. In another implementation, the controller is connected with other components of the system through a wired communication network, such as Ethernet, RS-485, Modbus, PROFIBUS, Ether-CAT, or other industrial fieldbus protocols.

In operation, the controller 1102 is configured to manage the movement, timing and speed of the conveyor assembly 104, ensuring synchronized transfer of the plurality of molded fiber structures between different assemblies. In an implementation, the controller 1102 is configured to receive position feedback signals from the different assemblies and adjusts the operations based on the position feedback signals. The controller 1102 further monitors position sensors on the conveyor assembly 104 to track the location of the plurality of molded fiber structures, ensuring precise alignment at each station. The controller 1102 is further configured to control the temperature across the different heating zones of the plurality of heating boards and maintains the specified temperature ranges from 600° C. to 800° C. for different groups of the plurality of heating elements. In an implementation, the controller 1102 is configured to process temperature sensor data, and make real-time adjustments to maintain optimal heating conditions for the lamination of the multi-layered peelable liner 302. Moreover, the controller 1102 is configured to manage the vacuum suction assembly 304 by regulating vacuum suction pressure levels and suction timings for the suction of the multi-layered peelable liner 302 towards the first surface of the plurality of molded fiber structures. In an implementation, the controller 1102 is configured to receive the real-time pressure feedback from various sensors in the vacuum suction assembly and adjusts the vacuum pump operation to maintain optimal suction levels. The controller also implements precise timing control, activating vacuum suction for 5 seconds to 20 seconds in coordination with the heating assembly 702. Simultaneously, the controller 1102 is configured to monitor the vacuum seal integrity through pressure sensors and make real-time adjustments if pressure fluctuations are detected, thereby ensuring the uniform adhesion of the multi-layered peelable liner 302 across the first surface of the plurality of molded fiber structures. Furthermore, the controller 1102 is configured to manage the retrieval of the multi-layered peelable liner 302 and the precise placement of the multi-layered peelable liner 302 over the plurality of molded structures by accurately positioning the movable jig 306 during the lamination process. Additionally, the controller 1102 is configured to manage the operation of the trimming assembly 502 by managing the timing and execution of cutting operations, thereby ensuring proper alignment and synchronization with the movement of separated molded fiber structures.

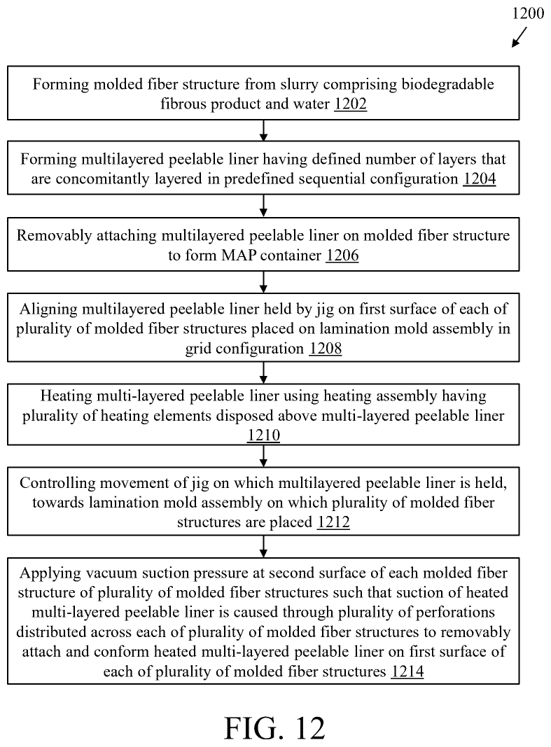

FIG. 12 is a flowchart that illustrates method of manufacturing the MAP container, in accordance with an embodiment of the present disclosure. FIG. 12 is described in conjunction with the FIGS. 1 to 11. With reference to FIG. 12, there is shown the method 1200 of manufacturing the MAP container. The method 1200 includes steps 1202 to 1214. In an implementation, the controller 1102 is configured to execute all the operations of the method 1200.

There is provided the method 1200 of manufacturing a modified atmosphere packaging (MAP) container. The method 1200 provides a comprehensive manufacturing process for manufacturing the MAP containers that are capable of maintaining a controlled internal atmosphere for food preservation. The method 1200 includes various manufacturing processes including forming the molded fiber structure 902, forming the multi-layer peelable liner 302, and laminating the multi-layer peelable liner 302 of the first surface 904 of the molded fiber structure 902. Furthermore, the method 1200 is configured to utilize controlled parameters for temperature, vacuum pressure, and timing to achieve proper adhesion between the multi-layer peelable liner 302 and the first surface 904 of the molded fiber structure 902.

At step 1202, the method 1200 includes forming the molded fiber structure 902 from a slurry comprising a biodegradable fibrous product and water. Initially, the selected biodegradable product is mixed with water to form a slurry, which is then poured and processed through some molding equipment. The molding equipment is configured to heat-press the poured slurry in the shape of a container while maintaining environmental compatibility. The molding equipment applies controlled pressure and temperature to transform the slurry into a solid three-dimensional structure with precise geometrical features. During the molding process, the molding equipment creates specific structural elements on the molded fiber structure 902, including the perforated surface pattern necessary for subsequent vacuum-based attachment of the multi-layered peelable liner 302, the plurality of de-nesting lugs for efficient stacking, and the overall container profile with controlled wall thickness.

In accordance with an embodiment, the molded fiber structure 902 has the first surface 904 and a second surface, wherein the first surface 904 is a product contact surface on which the multi-layered peelable liner 302 is removably attached. In an implementation, the first surface 904 of the molded fiber structure 902 is made rough with some texture of pattern to provide an optimal adhesion with the multi-layered peelable liner 302, while maintaining a controlled peelability. The molded fiber structure 902 further includes the set of perforations across its body, the set of perforations are distributed in a predetermined pattern to enable uniform vacuum pressure distribution during the attachment of the multi-layered peelable liner 302. Furthermore, the second surface of the molded fiber structure includes a rim profile, and a plurality of ribs configured to provide structural reinforcement to the molded fiber structure 902. The rim profile extends around the perimeter of the second surface, creating a raised edge that enhances container rigidity and provides stacking support to the molded fiber structure. The plurality of ribs is arranged in a radial pattern extending from the central region toward the rim, with additional circumferential ribs creating a grid-like support structure.

In accordance with an embodiment, the biodegradable fibrous product is one of: agro-pulp, recycled paper or cardboard, plant-based biodegradable fibers, wood-based biodegradable fibers, or a combination thereof. In an example, the biodegradable fibrous product is agro-pulp. The agro-pulp provides optimal fiber characteristics necessary for the molded fiber structure 902 formation. Derived from agricultural byproducts, such as wheat straw, rice straw, or sugarcane bagasse, the agro-pulp contains natural fibers that enable effective fiber bonding during the molding process while maintaining sufficient porosity for vacuum transmission. In another example, the biodegradable fibrous product is recycled paper or cardboard. The recycled paper or cardboard provides suitable fiber characteristics for the formation of molded fiber structure 902 through its processed cellulose fibers. The recycled material undergoes a refinement process to break down into individual fibers while maintaining an optimal fiber length for molding applications. In yet another example, the biodegradable fibrous product is agro-pulp, plant-based biodegradable fibers. The plant-based biodegradable fibers provide enhanced structural properties to the molded fiber structure 902 through the natural lignin content and high cellulose content in them. The plant-based biodegradable fibers are derived from sources such as hemp, jute, or bamboo, possess natural strength characteristics that create a stable network structure during molding. In another example, the biodegradable fibrous product is the wood-based biodegradable fibers. The wood-based biodegradable fibers provide exceptional strength and molding characteristics through their refined cellulose content. Thus, the ability to utilize the different biodegradable materials, either individually or in combinations, enables flexible manufacturing of the molded fiber structure 902 while maintaining consistent product quality.

At step 1204, the method 1200 includes forming the multi-layered peelable liner 302 having a defined number of layers that are concomitantly layered in a predefined sequential configuration, wherein a plurality of polyamide (PA) layers and an ethylene vinyl alcohol (EVOH) layer are sandwiched between a first set of polyethylene (PE) layers and a second set of PE layers. The multi-layered peelable liner 302 is formed by co-extruding the defined number of layers that are concomitantly layered in a predefined sequential configuration to achieve optimal barrier properties. Initially, the raw materials, including the PE, the PA, the EVOH and the tie layer materials, are initially processed in separate extruder compartments where the raw materials are heated to their respective melting points. Furthermore, the molten raw materials are then pushed through individual channels within a multi-manifold die. The multi-manifold die combines the molten layers of the different raw materials into a single, multi-layered structure by arranging the layers in a predefined sequential configuration (e.g., a first PE layer/a second PE layer/a first intermediate tie layer/a first PA layer/an EVOH layer/a second PA layer/a second intermediate tie layer/a third PE layer/a fourth PE layer). The multi-manifold die controls the thickness and distribution of each layer, ensuring uniform performance and quality. After the different layers are combined in the die, the multi-layered structure is extruded as a single sheet. The extruded sheet is then cooled and solidified, forming the multi-layered peelable liner 302.

In accordance with an embodiment, the defined number of layers are nine layers. The nine layers are created through a synchronized co-extrusion process where each layer is formed simultaneously in a specific sequence. The nine layers include two initial PE layers for sealing and moisture barrier, followed by a tie layer for interlayer adhesion, followed by two PA layers for mechanical strength, followed by another tie layer for adhesion, followed by two final PE layers for sealing and moisture barrier. Thus, the nine-layer configuration of the multi-layered peelable liner 302 enables optimal moisture and gas barrier properties of the multi-layered peelable liner 302 which maintaining the peelability of the multi-layered peelable liner 302.

In accordance with an embodiment, the defined number of layers are arranged in the predefined sequential configuration as follows: a first PE layer, a second PE layer, a first intermediate tie layer, a first PA layer, the EVOH layer, a second PA layer, a second intermediate tie layer, a third PE layer, and a fourth PE layer. The predefined sequential configuration of the defined number of layers of the multi-layered peelable liner 302 optimizes the moisture and gas barrier properties of the MAP container while ensuring the structural integrity and proper interlayer adhesion between the defined number of layers. In operation, the first PE layer and the second PE layer form the outer surface of the multi-layered peelable liner 302, providing moisture barrier properties and heat-sealing capability. In accordance with an embodiment, the method 1200 further comprises co-extruding the defined number of layers in a co-extruder in which the defined number of layers are attached together in the predefined sequential configuration for the formation of the multi-layered peelable liner 302. The first intermediate tie layer ensures strong adhesion between the second PE layers and the first PA layer. The first PA layer and the second PA layer provide mechanical strength and impact resistance while protecting the centrally placed EVOH layer, which creates an effective oxygen barrier essential for food preservation. The second intermediate tie layer ensures proper bonding between the second PA layer and the third PE layer. The third PE layer and fourth PE layer complete the structure, providing additional moisture barrier and sealing properties on the opposite surface of the multi-layered peelable liner 302.

In accordance with an embodiment, each of the first set of PE layers and the second set of PE layers has two PE layers that are in direct contact with each other. The first set of PE layers comprises the first PE layer and the second PE layer, where the second set of PE layers comprises the third PE layer and the fourth PE layer. During the co-extrusion process, the first set of PE layers and the second set of PE layers are extruded simultaneously at identical processing temperatures between 160° C. to 180° C. through adjacent channels in the multi-manifold die. The direct contact between the first set of PE layers and the second set of PE layers enables molecular entanglement during cooling, creating a strong cohesive bond between the first set of PE layers and the second set of PE layers while maintaining distinct functional properties from other material layers.

In accordance with an embodiment, the EVOH layer is sandwiched between the plurality of polyamide (PA) layers in the multi-layered peelable liner 302. The sandwiching of the EVOH layer is executed through precise co-extrusion where the EVOH layer is positioned between two PA layers during the simultaneous formation of multiple layers. The EVOH layer is sensitive to moisture but essential for oxygen barrier properties, thus the PA layers from both sides shield the EVOH layer from moisture exposure while providing mechanical strength to the overall structure of the multi-layered peelable liner 302.

In accordance with an embodiment, the co-extruding of the defined number of layers is performed such that: a thickness of each of the first set of PE layers is in a range of 9-24 micrometers (μm), a thickness of each of the plurality of PA layers is in a range of 10-15 micrometers (μm), a thickness of the EVOH layer is in a range of 12-22 micrometers (μm), and a thickness of each of the second set of PE layers is in a range of 9-24 micrometers (μm). In an example, the thickness of each of the first set of PE layers is 9 μm. In another example, thickness of each of the first set of PE layers is 24 μm. In yet another example, thickness of each of the first set of PE layers is 15 μm. The first set of PE layers are configured to provide primary moisture barrier properties and heat-sealing functionality to the multi-layered peelable liner 302. In an example, the thickness of each of the plurality of PA layers is 10 μm. In another example, the thickness of each of the plurality of PA layers is 15 μm. In yet another example, the thickness of each of the plurality of PA layers is 12 μm. The plurality of PA layers provides structural reinforcement and impact resistance to the multi-layered peelable liner 302 while protecting the EVOH layer. In an example, the thickness of the EVOH layer is 12 μm. In another example, the thickness of the EVOH layer is 22 μm. In yet another example, the thickness of the EVOH layer is 18 μm. The EVOH layer provides primary oxygen barrier properties to the multi-layered peelable liner 302, which enables maintaining modified atmosphere conditions within the MAP container. In an example, the thickness of each of the second set of PE layers is 9 μm. In another example, the thickness of each of the second set of PE layers is 24 μm. In yet another example, the thickness of each of the second set of PE layers is 18 μm. The second set of PE layers provides secondary moisture barrier properties and additional sealing functionality to the multi-layered peelable liner 302.

In accordance with an embodiment, the co-extruding of the defined number of layers is performed such that the co-extruded multi-layered peelable liner 302 comprises the plurality of PE layer in the range of 40-65 weight percent (wt. %), the plurality of PA layers in the range of 10 to 25 wt. %, and the EVOH layer in the range of 5-25 wt. %. In an example, the co-extruded multi-layered peelable liner 302 comprises the plurality of PE layer in 40 wt. %. In another example, the co-extruded multi-layered peelable liner 302 comprises the plurality of PE layer in 65 wt. %. In yet another example, the co-extruded multi-layered peelable liner 302 comprises the plurality of PE layer in 50 wt. %. The inclusion of the plurality of PE layers in the range of 40 wt. % to 65 wt. % ensures sufficient material for moisture barrier and sealing functions while allowing process optimization. In an example, the co-extruded multi-layered peelable liner 302 comprises the plurality of PA layers in 10 wt. %. In another example, the co-extruded multi-layered peelable liner 302 comprises the plurality of PA layers in 25 wt. %. In yet another example, the co-extruded multi-layered peelable liner 302 comprises the plurality of PA layers in 15 wt. %. The inclusion of the plurality of PA layers in the range of 10 wt. %. to 25 wt. %. provides optimal mechanical properties and protective functions to the multi-layered peelable liner 302. In an example, the co-extruded multi-layered peelable liner 302 comprises the EVOH layers in 5 wt. %. In another example, the co-extruded multi-layered peelable liner 302 comprises the EVOH layers in 25 wt. %. In yet another example, the co-extruded multi-layered peelable liner 302 comprises the EVOH layers in 15 wt. %. The inclusion of the EVOH layer in the range of 5 wt. % to 25 wt. % provides essential oxygen barrier properties critical for maintaining modified atmosphere conditions within the MAP container.

In accordance with an embodiment, the co-extruding of the defined number of layers is performed such that the co-extruded multi-layered peelable liner 302 further comprises a plurality of intermediate tie layers in the range of 2-10 weight percent (wt. %). In an example, the co-extruded multi-layered peelable liner 302 further comprises the plurality of intermediate tie layers in 2 wt. %. in another example, the co-extruded multi-layered peelable liner 302 further comprises the plurality of intermediate tie layers in 10 wt. %. In yet another example, the co-extruded multi-layered peelable liner 302 further comprises the plurality of intermediate tie layers in 6 wt. %. The inclusion of the plurality of intermediate tie layers in the range of 2 wt. % to 10 wt. % provides the interlayer adhesion between dissimilar materials (such as the PE layer and the PA layer) in the multi-layered peelable liner 302.

At step 1206, the method 1200 includes removably attaching the multi-layered peelable liner 302 on the molded fiber structure 902 to form the MAP container. In operation, the removable attachment of the multi-layered peelable liner 302 to the molded fiber structure 902 occurs through a coordinated sequence of steps involving the system for manufacturing the MAP container. Initially, the plurality of molded fiber structures is precisely positioned on the lamination mold assembly 102, which is placed above the vacuum suction assembly 304. At step 1208, the method 1200 includes aligning the multi-layered peelable liner 302 held by a movable jig 306 on the first surface of each of the plurality of molded fiber structures placed on the lamination mold assembly 102 in a grid configuration. The movable jig 306 retrieves the multi-layered peelable liner 302 from the liner roll 308 and positions the multi-layered peelable liner 302 above the lamination mold assembly 102 while maintaining proper tension and alignment. At step 1210, the method 1200 includes heating the multi-layered peelable liner 302 using the heating assembly 702 having a plurality of heating elements disposed above the multi-layered peelable liner 302, wherein the temperature of the plurality of heating elements are maintained at a temperature in the range of 600 degrees Celsius to 800 degrees Celsius. The heating assembly 702, comprising the plurality of heating boards with the plurality of heating elements arranged in the grid pattern, starts to heat the multi-layered peelable liner 302. In accordance with an embodiment, the heating duration of heating of the multi-layered peelable liner 302 is 6 seconds to 12 seconds. In an example, the heating duration of heating of the multi-layered peelable liner 302 is 6 seconds. In another example, the heating duration of heating of the multi-layered peelable liner 302 is 12 seconds. In yet another example, the heating duration of heating of the multi-layered peelable liner 302 is 9 seconds. At step 1212, the method 1200 includes controlling a movement of the movable jig 306 on which the multi-layered peelable liner 302 is held, towards the lamination mold assembly 102 on which the plurality of molded fiber structures is placed. After heating the multi-layered peelable liner 302 for 6 seconds to 12 seconds, the movable jig 306 lowers the heated multi-layered peelable liner 302 towards the first surface the plurality of molded fiber structures. In accordance with an embodiment, the method 1200 further comprises applying vacuum suction pressure at the second surface of each molded fiber structure of the plurality of molded fiber structures such that a suction of the heated multi-layered peelable liner 302 is caused through the plurality of perforations distributed across each of the plurality of molded fiber structures to removably attach and conform the heated multi-layered peelable liner 302 on the first surface of each of the plurality of molded fiber structures, wherein the heating is continued during the application of the vacuum suction pressure until the heated multi-layered peelable liner 302 conforms on the first surface. The vacuum suction assembly 304 then activates, applying controlled vacuum pressure through the perforations in each of the plurality of molded fiber structures for 5 seconds to 20 seconds. The vacuum action pulls the heated multi-layered peelable liner 302 uniformly against each the first surface of each of the plurality of molded fiber structures, ensuring proper conformity of the multi-layered peelable liner 302 to surface contours while creating consistent adhesion that maintains peelability. In accordance with an embodiment, the vacuum suction pressure is applied for a suction time of 5 seconds to 20 seconds. In an example, the vacuum suction pressure is applied for a suction time of 5 seconds. In another example, the vacuum suction pressure is applied for a suction time of 12 seconds. In yet another example, the vacuum suction pressure is applied for a suction time of 9 seconds.

In accordance with an embodiment, the method 1200 further comprises segregating the plurality of molded fiber structures at a trimming station on which the multi-layered peelable liner 302 is removably attached by concurrent trimming of the multi-layered peelable liner 302 at a surrounding region of each molded fiber structure. The trimming operation is performed using the trimming assembly 502, which incorporates precisely aligned cutting surfaces within frame 506, supported by the plurality of vertical supports. The trimming assembly 502 simultaneously cuts the excess multi-layered peelable liner 302 along predetermined cut lines surrounding each pf the plurality of molded fiber structures, thereby maintains precise alignment through the vertical supports while applying uniform pressure to ensure clean separation of the individual laminated molded fiber structure, which as a unit is termed as the MAP container.

In accordance with an embodiment, the method 1200 further comprises heat-sealing a lidding film on the MAP container along a peripheral edge of the MAP container when a food product is present in the MAP container. The heat-sealing of the MAP container by the lidding film is executed through controlled application of heat and pressure along the peripheral edges of the MAP container by specifically designed heat-sealing the MAP container. The heat-sealing of the MAP container begins with precise positioning of the lidding film over the MAP container containing the food product. The heat-sealing equipment applies localized heat to activate the sealing properties of the lidding film. Simultaneously, the controlled pressure is applied through sealing plates of the heat-sealing equipment that contact only the peripheral edges of the MAP container.

In accordance with an embodiment, the method 1200 further comprises concurrently controlling three control parameters comprising a heating temperature to differentially adjust temperature of a plurality of heating elements distributed across each heating board in a heating assembly 702, a vacuum suction pressure to allow the multi-layered peelable liner 302 to uniformly adhere and conform on the first surface 904 of the molded fiber structure 902 while maintaining a peelability of the multi-layered peelable liner 302, and a suction time to removably attach the heated multi-layered peelable liner 302 to the first surface 904 of the molded fiber structure 902. The heating temperature is adjusted differentially across the plurality of heating elements in the heating assembly 702 to ensure that the multi-layered peelable liner 302 is heated optimally before application. The vacuum suction pressure is applied to create uniform contact between the multi-layered peelable liner 302 and the molded fiber structure 902 without excessive force that could compromise peelability of the multi-layered peelable liner 302. Moreover, the suction time is controlled to allow sufficient bonding without over-adhering the multi-layered peelable liner 302, ensuring that the multi-layered peelable liner 302 remains removable when required. Thus, by controlling the heating temperature, vacuum suction pressure, and suction time, the MAP container attains a uniform adhesion of the multi-layered peelable liner 302, prevents defects such as air pockets or weak bonding, and maintains the peelability of the multi-layered peelable liner 302 for user convenience.

Advantageously, the method 1200 for manufacturing the MAP container provides the MAP container with enhance food preservation, structural integrity, and manufacturing efficiency. The method 1200 enables the formation of the molded fiber structure 902 using biodegradable materials, such as agro-pulp, recycled paper, plant-based biodegradable fibers, and wood-based biodegradable fibers. The use of such materials makes the MAP container environmentally sustainable while maintaining strength and durability. The method 1200 further ensures that the molded fiber structure 902 has specific features, including the set of perforated across the body of the molded fiber structure 902 for vacuum-based attachment of the multi-layered peelable liner 302, the plurality of de-nesting lugs for efficient stacking the molded fiber structure 902, and a reinforced rim profile for enhance stability of the molded fiber structure 902. Moreover, the method provides a process for forming a multi-layered peelable liner 302 through a co-extrusion process, which ensures precise layer distribution and uniform performance. The multi-layered peelable liner 302 consists of multiple layers, including the plurality of PE layers, the plurality of PA layers, the EVOH layer, and the plurality of intermediate tie layers, which are arranged in a predefined sequential configuration, which enhances the barrier properties of the MAP container by preventing moisture and gas transmission, thereby extending the shelf life of packaged food. The method 1200 maintains strict control over processing parameters such as temperature, vacuum pressure, and timing, ensuring strong adhesion between the multi-layered peelable liner 302 and the molded fiber structure 902 while allowing for controlled peelability. By incorporating the material selection, advanced molding techniques, and optimized co-extrusion processes, the method 1200 ensures high-quality MAP containers that provide superior food preservation capabilities.

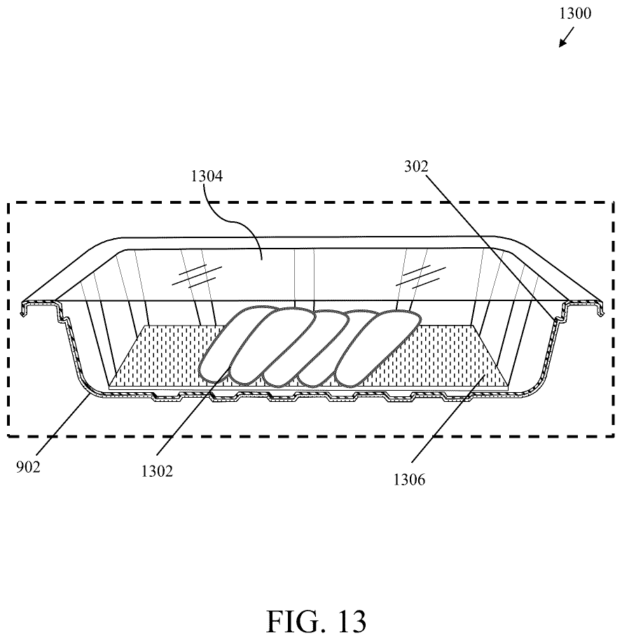

FIG. 13 is a diagram that illustrates a MAP container having a food product packaged inside, in accordance with an embodiment of the present disclosure. FIG. 13 is described in conjunction with the FIGS. 1 to 12. With reference to FIG. 13, there is shown the MAP container 1300 having the food product 1302 package inside.

In an exemplary scenario, there is provided the MAP container 1300 that includes the molded fiber structure 902 and the multi-layered peelable liner 302 laminated on the first surface 904 of the molded fiber structure 902. The MAP container 1300 further includes a lidding film 1304 and a moisture absorbent pad 1306. The MAP container is configured to provide an enhanced food packaging for the food product 1302 by maintaining a controlled atmosphere inside the MAP container 1300. The food product 1302 is stored inside the MAP container 1300, which is in contact with the first surface 904 and the multi-layered peelable liner 302 of the MAP container 1300. Examples of the food product 1302 may include but are not limited to vegetables, fruits, meat products, dairy products, poultry products, seafood, ready-to-eat meals, and the like without affecting the scope of the present disclosure. Moreover, the MAP container 1300 provides an environment conducive for preserving the freshness, texture, and quality of the stored food product 1302 for an extended period of time (e.g., shelf life of 6 to 12 months for meat products).

The lidding film 1304 refers to a sealing film that is used to securely enclose the MAP container 1300 in order to form an airtight and tamper-evident seal over the MAP container 1300 thereby ensuring an improved seal integrity of the MAP container 1300. Moreover, the lidding film 1304 in combination with the multi-layered peelable liner 302 is used to maintain the moisture level and controlled oxygen exposure, which is required by every food product, especially the meat products stored in the MAP container 1300 to improve its shelf life and maintain its taste, color, odor, and the nutritional levels. In an implementation, the lidding film 1304 may include multiple layers of barrier materials, such as Polyethene (PE), Polyamide (PA), Ethylene Vinyl Alcohol (EVOH), and the like, which are used to restrict the oxygen ingress and maintains the overall moisture level within the MAP container 1300. In an implementation, the lidding film 1304 includes easy-peel features to facilitate an easy and user-friendly removal of the lidding film 1304 from the top of the MAP container 1300 without compromising the seal integrity of the lidding film 1304.

The MAP container 1300 further comprises the moisture absorbent pad 1306 disposed on the first surface 904 of the molded fiber structure 902. The moisture absorbent pad 1306 refers to a thick layer of high-capacity absorbent materials, such as cellulose fibers, superabsorbent polymers, or other biodegradable composites, which are configured to manage and control excess moisture within the MAP container 1300. Moreover, the moisture absorbent pad 1306 provides high moisture retention within the MAP container 1300 while ensuring that the absorbed moisture or the meat purge remains trapped within the moisture absorbent pad 1306 and does not leak out of the MAP container 1300. In an implementation, the moisture absorbent pad 1306 includes an antimicrobial treatment, such as a silver-ion coating or natural antimicrobial agents, such as citric acid derivatives, which inhibit the growth of harmful bacteria that are found in the moist environment. As a result, the moisture absorbent pad 1306 is used to maintain the required moisture levels inside the MAP container 1300 that enhances the shelf life and freshness of the food product 1302 (e.g., meat product). As a result, the multi-layered peelable liner 302 and the lidding film 1304 that seals the MAP container 1300 act as the gas barrier and modifies internal atmosphere of the MAP container 1300 is used to maintain the required carbon dioxide levels thereby enhancing the shelf life of the food product 1302 while maintaining the freshness, taste, color, and odor of the food product 1302.

### Experimental Part

### 1. Forming the Molded Fiber Structure

Example 1: Initially, for experimental setup, 5 grams of slurry made up of agro-pulp (specifically, sugarcane bagasse) are mixed with 100 milliliters (ml) of water in the pulping machine at a temperature of 25° C. It is understood by one of ordinary skill in the art that the amount of slurry can be increased to kilograms and proportionally other items like water may be added in the pulping machine in an industrial setup using the above information, without limiting the scope of the disclosure. For example, for industrial setup, 500 kilograms of slurry made up of recycled agro waste (specifically, sugarcane bagasse) maybe mixed with 10,000 liters of water in the pulping machine at ambient temperature of 25° C. The mixing is continued for 30 minutes to achieve uniform consistency, resulting in a homogeneous pulp suitable for molding. Further, the homogeneous pulp is fed into a pulp molding machine equipped with a mold cavity that determines the shape, size, and structural features of the resulting molded fiber. The resulting molded fiber undergoes a drying process at temperature of 300° C. for 10 hours to achieve optimal strength and dimensional stability. After drying, the dried molded fiber is precision-trimmed to obtain the molded fiber structure 902.

Example 2: Initially, for experimental setup, 5 grams of slurry made up of agro-pulp (specifically, sugarcane bagasse) are mixed with 100 milliliters (ml) of water in the pulping machine at ambient temperature of 25° C. The mixing is continued for 30 minutes to achieve uniform consistency, resulting in a homogeneous pulp suitable for molding. Further, the homogeneous pulp is fed into a pulp molding machine equipped with a mold cavity that determines the shape, size, and structural features of the resulting molded fiber. The resulting molded fiber undergoes a drying process at temperature of 250° C. for 5 hours to achieve optimal strength and dimensional stability. After drying, the dried molded fiber is precision-trimmed to obtain the molded fiber structure 902.

Example 3: Initially, for experimental setup, 5 grams of slurry made up of agro-pulp (specifically, sugarcane bagasse) is mixed with 100 milliliters (ml) of water in the pulping machine at ambient temperature of 25° C. The mixing is continued for 30 minutes to achieve uniform consistency, resulting in a homogeneous pulp suitable for molding. Further, the homogeneous pulp is fed into a pulp molding machine equipped with a mold cavity that determines the shape, size, and structural features of the resulting molded fiber. The resulting molded fiber undergoes a drying process at temperature of 150° C. for 5 hours to achieve optimal strength and dimensional stability. After drying, the dried molded fiber is precision-trimmed to obtain the molded fiber structure. It is to be understood by one of ordinary skill in the art that the amount of slurry can be increased to kilograms and proportionally other items like water may be added in the pulping machine in an industrial setup using the above information, without limiting the scope of the disclosure in the above examples.

### 2. Forming the Multi-Layered Peelable Liner

Example 1: Initially, a first PE layer that acts as the base layer with a thickness of approximately 9 micrometers (μm) is taken. A second PE layer, also with a thickness of 9 μm, is extruded onto the first PE layer. Further, a tie layer, composed of an adhesive polymer, is applied to bond the PE layers to the subsequent PA layer. Then, a first PA layer with a thickness of 10 μm is extruded onto the tie layer. Furthermore, an EVOH layer with a thickness of 5 μm is extruded onto the first PA layer. Then, a second tie layer is extruded onto the EVOH layer. Moreover, a third PE layer with a thickness of 9 μm is extruded onto the second tie layer. Finally, a fourth PE layer with a thickness of 9 μm is extruded onto the third PE layer as the outermost layer to make the multi-layered peelable liner 302. The formed multi-layered peelable liner 302 is composed of the PE at 40 wt. %, the PA at 10 wt. %, the EVOH at 5 wt. %, and the tie at 5 wt. % (as described in Table 1).

Example 2: Initially, a first PE layer that acts as the base layer with a thickness of approximately 11 micrometers (μm) is taken. A second PE layer, also with a thickness of 11 μm, is extruded onto the first PE layer. Further, a tie layer, composed of an adhesive polymer, is applied to bond the PE layers to the subsequent PA layer. Then, a first PA layer with a thickness of 12 μm is extruded onto the tie layer. Furthermore, an EVOH layer with a thickness of 15 μm is extruded onto the first PA layer. Moreover, a second PA layer with a thickness of 12 μ is extruded onto the EVOH layer. Then, a second tie layer is extruded onto the second PA layer. Furthermore, a third PE layer with a thickness of 11 μm is formed on the second tie layer. Finally, a fourth PE layer with a thickness of 11 μm is extruded onto the third PE layer as the outermost layer to make the multi-layered peelable liner 302. The formed multi-layered peelable liner is composed of the PE at 50 wt. %, the PA at 15 wt. %, the EVOH at 10 wt. %, and the tie at 10 wt. % (as described in the Table 1). However, the multi-layered peelable liner fails the different tests (as described in the Table 1).

Example 3: Initially, a first PE layer that acts as the base layer with a thickness of approximately 24 micrometers (μm) is taken. A second PE layer, also with a thickness of 24 μm, is extruded onto the first PE layer. Further, a third PE layer, also with a thickness of 24 μm is extruded onto the second PE layer. Then, a fourth PE layer, also with a thickness of 24 μm is extruded onto the third PE layer. Furthermore, an EVOH layer of a thickness of 22 μm is extruded onto the fourth PE layer. Then, a fifth PE layer with a thickness of 24 μm, is extruded onto the EVOH layer. Moreover, the sixth PE layer, also with a thickness of 24 μm, is extruded onto the fifth PE layer. Then, the seventh PE layer, also with a thickness of 24 μm is extruded onto the sixth PE layer. Finally, the eighth PE layer, also with a thickness of 24 μm is extruded onto the seventh PE layer to make the multi-layered peelable liner 302. The formed multi-layered peelable liner is composed of the PE at 85 wt. % and the EVOH at 15 wt. %. However, the multi-layered peelable liner fails the different tests (as described in the Table 1).

### 3. Manufacturing the MAP Container

Example 1: Initially, a molded fiber structure 902 is placed on a lamination mold within a lamination mold assembly 102, which is then positioned on a vacuum suction assembly 304. An example of the system is described, for example, in FIG. 7. A multi-layered peelable liner 302 is aligned on the first surface 904 of the molded fiber structure 902. A heating assembly 702, positioned above the multi-layered peelable liner 302 and equipped with a plurality of heating boards, is maintained at a temperature of approximately 600° C., which causes the multi-layered peelable liner 302 to heat and soften within 12 seconds. Simultaneously, a plurality of vacuum suction elements in the vacuum suction assembly 304 creates suction pressure through the perforations in the molded fiber structure 902 for 20 seconds, which causes the heated multi-layered peelable liner 302 to conform tightly to the first surface 904 of the molded fiber structure 902, ensuring proper adhesion and uniform coverage, which results in the preparation of the MAP container 1300. (as described in Table 3)

Example 2: Initially, a molded fiber structure 902 is placed on a lamination mold within a lamination mold assembly 102, which is then positioned on a vacuum suction assembly 304. A multi-layered peelable liner 302 is aligned on the first surface 904 of the molded fiber structure 902. A heating assembly 702, positioned above the multi-layered peelable liner 302 and equipped with a plurality of heating boards, is maintained at a temperature of approximately 800° C., which causes the multi-layered peelable liner 302 to heat and soften within 6 seconds. Simultaneously, a plurality of vacuum suction elements in the vacuum suction assembly 304 creates suction pressure through the perforations in the molded fiber structure 902 for 5 seconds, which causes the heated multi-layered peelable liner 302 to conform tightly to the first surface of the molded fiber structure 902, ensuring proper adhesion and uniform coverage, which results in the preparation of the MAP container 1300. (as described in the Table 3)

Example 3: Initially, a molded fiber structure 902 is placed on a lamination mold within a lamination mold assembly 102, which is then positioned on a vacuum suction assembly 304. A multi-layered peelable liner 302 is aligned on the first surface 904 of the molded fiber structure 902. A heating assembly 702, positioned above the multi-layered peelable liner 302 and equipped with a plurality of heating boards, is maintained at a temperature of approximately 700° C., which causes the multi-layered peelable liner 302 to heat and soften within 8 seconds. Simultaneously, a plurality of vacuum suction elements in the vacuum suction assembly 304 creates suction pressure through the perforations in the molded fiber structure 902 for 12 seconds, which causes the heated multi-layered peelable liner 302 to conform tightly to the first surface 904 of the molded fiber structure 902, ensuring proper adhesion and uniform coverage, which results in the preparation of the MAP container 1300 (as described in the Table 3).

The MAP container 1300 comprising the molded fiber structure 902 and the multi-layered peelable liner 302 is further tested for a first pinhole test (with 95% ethyl alcohol), a second pinhole test with hot oil, a vacuum leakage test and shelf life study. In the first pinhole test, the MAP container 1300 is inspected for pinholes or breaches that could compromise the barrier properties of the multi-layered peelable liner 302. The second pinhole test tests the resistance of the multi-layered peelable liner 302 to penetration and degradation when exposed to high-temperature environments. Furthermore, during the vacuum leakage test, the multi-layered peelable liner 302 is subjected to vacuum pressure of up to 15 inches of mercury (inHg) while the multi-layered peelable liner 302 is submerged in water. Additionally, the shelf life study evaluates the long-term reliability of the multi-layered peelable liner 302. The multi-layered peelable liner 302 is subjected to environmental conditions such as temperature, humidity, and exposure to oxygen over an extended time period, typically from 6 months to 12 months. Table 1 represents the result of the different tests (i.e., the first pinhole test (with 95% ethyl alcohol) (T1), the second pinhole test with hot oil (T2), the vacuum leakage test (T3), and the shelf life study (T4)) of the multi-layered peelable liners with different layer compositions.

### Testing for Pinholes, Vacuum Leakage and Shelf Life

TABLE 1

| | Composition | | | | | | | | | | | |
|---|---|---|---|---|---|---|---|---|---|---|---|---|
| | of the dif- | | | | | H_{T} | V_{T} | Adhesion | Different Tests | | | |
| S. No | ferent layers | A | B | C | D | (s) | (s) | Check | T1 | T2 | T3 | T4 |
| 1 | a first PE layer- | 80 | 2 | 4.5 | 675 | 8 | 5 | Pass | Fail | Fail | Fail | Fail |
| | a second PE layer- | | | | | | | | | | | |
| | a third PE layer- | | | | | | | | | | | |
| | a fourth PE layer- | | | | | | | | | | | |
| | an EVOH layer- | | | | | | | | | | | |
| | a fifth PE layer- | | | | | | | | | | | |
| | a sixth PE layer- | | | | | | | | | | | |
| | a seventh PE- | | | | | | | | | | | |
| | an eight PE layer | | | | | | | | | | | |
| | (EVOH: 15%, PE: 83%, | | | | | | | | | | | |
| | Tie: 2%) | | | | | | | | | | | |
| 2 | a first PE layer- | 125 | 1.3 | 3 | 675 | 6 | 8 | Pass | Pass | Pass | Pass | Pass |
| | a second PE layer- | | | | | | | | | | | |
| | a first Tie layer- | | | | | | | | | | | |
| | a first PA layer- | | | | | | | | | | | |
| | a first EVOH layer- | | | | | | | | | | | |
| | a second PA layer- | | | | | | | | | | | |
| | a second Tie layer- | | | | | | | | | | | |
| | a third PE layer- | | | | | | | | | | | |
| | a fourth PE layer | | | | | | | | | | | |
| | (PA: 20%, EVOH: 15%, | | | | | | | | | | | |
| | PE: 63%, Tie: 2%) | | | | | | | | | | | |
| 3 | a first PE layer- | 150 | 1 | 2 | 700 | 9 | 8 | Pass | Fail | Fail | Fail | Fail |
| | a second PE layer- | | | | | | | | | | | |
| | a first Tie layer- | | | | | | | | | | | |
| | a first PA layer- | | | | | | | | | | | |
| | a first EVOH layer- | | | | | | | | | | | |
| | a second PA layer- | | | | | | | | | | | |
| | a second Tie layer- | | | | | | | | | | | |
| | a third PE layer- | | | | | | | | | | | |
| | a second PE layer | | | | | | | | | | | |
| | (PA: 20%, EVOH: 15%, | | | | | | | | | | | |
| | PE: 63%, Tie: 2%) | | | | | | | | | | | |
| 4 | a first PE layer- | 150 | 1 | 2 | 675 | 10 | 8 | Pass | Pass | Pass | Pass | Pass |
| | a second PE layer- | | | | | | | | | | | |
| | a first Tie layer- | | | | | | | | | | | |
| | a first PA layer - | | | | | | | | | | | |
| | first EVOH layer- | | | | | | | | | | | |
| | a second PA layer- | | | | | | | | | | | |
| | a second Tie layer- | | | | | | | | | | | |
| | a third PE layer- | | | | | | | | | | | |
| | a fourth PE layer | | | | | | | | | | | |
| | (PA: 20%, EVOH: 15%, | | | | | | | | | | | |
| | PE: 63%, Tie: 2%) | | | | | | | | | | | |
| 5 | a first PE layer- | 150 | 1 | 2 | 675 | 11 | 8 | Pass | Fail | Fail | Fail | Fail |
| | a second PE layer- | | | | | | | | | | | |
| | a first Tie layer- | | | | | | | | | | | |
| | a first PA layer- | | | | | | | | | | | |
| | an EVOH layer- | | | | | | | | | | | |
| | a second PA layer- | | | | | | | | | | | |
| | a second Tie layer- | | | | | | | | | | | |
| | a third PE layer | | | | | | | | | | | |
| | a fourth PE layer | | | | | | | | | | | |
| | (PA: 20%, EVOH: 15%, | | | | | | | | | | | |
| | PE: 63%, Tie: 2%) | | | | | | | | | | | |

The Table 1 represents multi-layered peelable liners with different compositions of layers having a total thickness (i.e., A) in micrometers (μm), water vapor transmission rate (i.e., B) measured in gm/m²/day as per ASTM D1249, oxygen transmission rate (i.e., C) measured in cc/m²/day as per ASTM D3985. Furthermore, the sixth column (i.e., D) represents the temperature of the plurality of heating elements in ° C. Moreover, the seventh column (denoted by HT) represents heating time or (heating duration) of the multi-layered peelable liner and the eight column represents vacuum time (i.e., the duration of time for which the vacuum suction assembly 304 applies the vacuum suction pressure), each measured in seconds. The night column represents the adhesion check of the multi-layered peelable liner 302. Moreover, the Table 2 represents the result of the different tests (i.e., the first pinhole test (with 95% ethyl alcohol) denoted by T1, the second pinhole test with hot oil denoted by T2, the vacuum leakage test denoted by T3, and the test for shelf life study denoted by T4) of the multi-layered peelable liners with different layer compositions.

Furthermore, the Table 1 shows that the multi-layered peelable liner with a thickness of 150 μm, having WVTR of 1 gm/m²/day and OTR of 2 cc/m²/day, heated at a temperature 675° C. for 10 seconds and vacuum suctioned for 8 seconds with the first PE layer—the second PE layer—the first Tie layer—the first PA layer—the first EVOH layer—the second PA layer—the second Tie layer—the third PE layer—the fourth PE layer, the composition of the PA at 20 wt. %, the EVOH at 15 wt. %, the PE at 63 wt. %, and the Tie at 2wt. % passes the first pinhole test (with 95% ethyl alcohol), the second pinhole test with hot oil, the vacuum leakage test, and the shelf life study, while other multi-layered peelable liner fails one or more tests.

### Testing Oxygen Transmission Rates (OTR) and Water Vapor Transmission Rates (WVTR)

The MAP container 1300 is further tested for oxygen transmission rates (OTR) and water vapor transmission rates (WVTR) to ensure the suitability of the MAP container 1300 for Modified Atmosphere Packaging (MAP) applications. Table 3 represents WVTR and OTR readings for the multi-layered peelable liner 302 with different composition of different layers (i.e., the plurality of PE layers, the plurality of PA layer, the EVOH layers, the plurality of Tie layers). The WVTR readings are taken at American Society for Testing and Materials (ASTM), specifically, ASTM D1249, which is a method used to measure the rate at which water vapor passes through a material, expressed in grams per square meter per day (gm/m²/day). The OTR readings are taken at ATSMD3986, which is a method used to measure the rate at which oxygen passes through a material, expressed in cubic centimeters per square meter per day (cc/m²/day).

TABLE 2

| | | | WVTR | OTR |
|---|---|---|---|---|
| | Composition of the | Thickness | (ASTM D1249 | (ASTM D3985 |
| S. No | different layers | (μ) | gm/m2/day) | cc/m2/day) |
| 1 | a first PE layer- a second PE layer- | 80 | 2 | 4.5 |
| | a third PE layer- a fourth PE layer- | | | |
| | an EVOH layer- a fifth PE layer- | | | |
| | a sixth PE layer- a seventh PE- | | | |
| | an eight PE layer | | | |
| | (EVOH: 15%, PE: 83%, Tie: 2%) | | | |
| 2 | A first PE layer- a second PE layer- | 125 | 1.3 | 3 |
| | a first Tie layer- a first PA layer- | | | |
| | a first EVOH layer- a second PA layer- | | | |
| | a second Tie layer- a third PE layer- | | | |
| | a fourth PE layer | | | |
| | (PA: 20%, EVOH: 15%, | | | |
| | PE: 63%, Tie: 2%) | | | |
| 3 | a first PE layer- a second PE layer- | 150 | 1 | 2 |
| | a first Tie layer- a first PA layer- | | | |
| | a first EVOH layer- a second PA layer- | | | |
| | a second Tie layer- a third PE layer- | | | |
| | a second PE layer | | | |
| | (PA: 20%, EVOH: 15%, | | | |
| | PE: 63%, Tie: 2%) | | | |
| 4 | a first PE layer- a second PE layer- | 150 | 1 | 2 |
| | a first Tie layer-a first PA layer - | | | |
| | first EVOH layer-a second PA layer- | | | |
| | a second Tie layer- a third PE layer- | | | |
| | a fourth PE layer | | | |
| | (PA: 20%, EVOH: 15%, | | | |
| | PE: 63%, Tie: 2%) | | | |
| 5 | a first PE layer- a second PE layer- | 150 | 1 | 2 |
| | a first Tie layer- a first PA layer- | | | |
| | an EVOH layer- a second PA layer- | | | |
| | a second Tie layer- a third PE layer | | | |
| | a fourth PE layer | | | |
| | (PA: 20%, EVOH: 15%, | | | |
| | PE: 63%, Tie: 2%) | | | |

As described in Table 2, it was found that the multi-layered peelable liner with an OTR less than or equal to 5 cc/m²/day and a WVTR less than or equal to 5 gm/m²/day passes both the OTR and WVTR tests. Evidently, the multi-layered peelable liner comprising a first PE layer, a second PE layer, a first Tie layer, a first PA layer, an EVOH layer, a second PA layer, a second Tie layer, a third PE layer, and a fourth PE layer, which has an OTR of 1 cc/m²/day and a WVTR of 2 gm/m²/day, passes both the OTR and WVTR tests. Therefore, this configuration can be used for making the multi-layered peelable liner 302.

### Testing for Adhesion and Peel-off (Peelability)

Based on this test, it was found that the adhesion strength and peelability of the multi-layered peelable liner 302 depends on following factors: temperature of the heating element used to heat the multi-layered peelable liner 302, duration for which the multi-layered peelable liner 302 is heated and the duration for which the vacuum suction pressure in applied to the multi-layered peelable liner 302. Ideally, the adhesion strength of the multi-layered peelable liner should be in the range of 1 to 5 N/15 mm and the multi-layered peelable liner should peel off cleanly without leaving residue or damaging the molded fiber structure. Table 3 below represents the results of the Adhesion and Peel-off Test for different compositions of the multi-layered peelable liner under varying process parameters, including the temperature of the heating element, heating time, and vacuum time.

TABLE 3

| | | Temperature | | Vacuum | Adhesion |
|---|---|---|---|---|---|
| | Composition of the | of Heating | Heating Time | Time | and Peel- |
| S. No | different layers | Element (° C.) | (seconds) | (seconds) | off Test |
| 1 | a first PE layer- a second PE layer- | 675 | 8 | 5 | Fail |
| | a third PE layer- a fourth PE layer- | | | | |
| | an EVOH layer- a fifth PE layer- | | | | |
| | a sixth PE layer- a seventh PE- | | | | |
| | an eight PE layer | | | | |
| | (EVOH: 15%, PE: 85%) | | | | |
| 2 | a first PE layer- a second PE layer- | 675 | 6 | 8 | Pass |
| | a first Tie layer- a first PA layer- | | | | |
| | a first EVOH layer- a second PA layer- | | | | |
| | a second Tie layer- a third PE layer- | | | | |
| | a fourth PE layer | | | | |
| | (PA: 20%, EVOH: 15%, | | | | |
| | PE: 63%, Tie: 2%) | | | | |
| 3 | a first PE layer- a second PE layer- | 700 | 9 | 8 | Fail |
| | a first Tie layer- a first PA layer- | | | | |
| | a first EVOH layer- a second PA layer- | | | | |
| | a second Tie layer- a third PE layer- | | | | |
| | a second PE layer | | | | |
| | (PA: 20%, EVOH: 15%, | | | | |
| | PE: 63%, Tie: 2%) | | | | |
| 4 | a first PE layer- a second PE layer- | 675 | 10 | 8 | Pass |
| | a first Tie layer-a first PA layer - | | | | |
| | first EVOH layer-a second PA layer- | | | | |
| | a second Tie layer- a third PE layer- | | | | |
| | a fourth PE layer | | | | |
| | (PA: 20%, EVOH: 15%, | | | | |
| | PE: 63%, Tie: 2%) | | | | |
| 5 | a first PE layer- a second PE layer- | 675 | 11 | 8 | Fail |
| | a first Tie layer- a first PA layer- | | | | |
| | an EVOH layer- a second PA layer- | | | | |
| | a second Tie layer- a third PE layer | | | | |
| | a fourth PE layer | | | | |
| | (PA: 20%, EVOH: 15%, | | | | |
| | PE: 63%, Tie: 2%) | | | | |

As described in Table 3, it was found that the multi-layered peelable liner 302, having a first PE layer, a second PE layer, a first Tie layer, a first PA layer, a first EVOH layer, a second PA layer, a second Tie layer, a third PE layer, and a fourth PE layer, passes the Adhesion and Peel-off Test when heated at 675° C. for 6 seconds and subjected to vacuum suction pressure for 8 seconds. The same multi-layered peelable liner 302 also passes the Adhesion and Peel-off Test when heated at 675° C. for 10 seconds and subjected to vacuum suction pressure for 8 seconds. However, the multi-layered peelable liner 302 fails the Adhesion and Peel-off Test when heated for less than 6 seconds or more than 12 seconds.

Modifications to embodiments of the present disclosure described in the foregoing are possible without departing from the scope of the present disclosure as defined by the accompanying claims. Expressions such as “including,” “comprising,” “incorporating,” “have,” “is” used to describe, and claim the present disclosure are intended to be construed in a non-exclusive manner, namely allowing for items, components or elements not explicitly described also to be present. Reference to the singular is also to be construed to relate to the plural. The word “exemplary” is used herein to mean “serving as an example, instance, or illustration.” Any embodiment described as “exemplary” is not necessarily to be construed as preferred or advantageous over other embodiments or to exclude the incorporation of features from other embodiments. The word “optionally” is used herein to mean “is provided in some embodiments and not provided in other embodiments.” It is appreciated that certain features of the present disclosure, which are, for clarity, described in the context of separate embodiments, may also be provided in combination in a single embodiment. Conversely, various features of the invention, which are, for brevity, described in the context of a single embodiment, may also be provided separately or in any suitable combination or as suitable in any other described embodiment of the disclosure.

1. A method of manufacturing a modified atmosphere packaging (MAP) container, comprising:
forming a molded fiber structure from a slurry comprising a biodegradable fibrous product and water;
forming a multi-layered peelable liner having a defined number of layers that are concomitantly layered in a predefined sequential configuration, wherein a plurality of polyamide (PA) layers and an ethylene vinyl alcohol (EVOH) layer are sandwiched between a first set of polyethylene (PE) layers and a second set of PE layers; and
removably attaching the multi-layered peelable liner on the molded fiber structure to form the MAP container.

2. The method according to claim 1, wherein the biodegradable fibrous product is one of: agro-pulp, recycled paper or cardboard, plant-based biodegradable fibers, wood-based biodegradable fibers, or a combination thereof.

3. The method according to claim 1, wherein the defined number of layers are nine layers.

4. The method according to claim 1, wherein the defined number of layers are arranged in the predefined sequential configuration as follows: a first PE layer, a second PE layer, a first intermediate tie layer, a first PA layer, the EVOH layer, a second PA layer, a second intermediate tie layer, a third PE layer, and a fourth PE layer.

5. The method according to claim 1, wherein each of the first set of PE layers and the second set of PE layers has two PE layers that are in direct contact with each other.

6. The method according to claim 1, wherein the EVOH layer is sandwiched between the plurality of polyamide (PA) layers in the multi-layered peelable liner.

7. The method according to claim 1, further comprising co-extruding the defined number of layers in a co-extruder in which the defined number of layers are attached together in the predefined sequential configuration for the forming of the multi-layered peelable liner.

8. The method according to claim 7, wherein the co-extruding of the defined number of layers is performed such that:
a thickness of each of the first set of PE layers is in a range of 9-24 micrometers (μm);
a thickness of each of the plurality of PA layers is in a range of 10-15 micrometers (μm);
a thickness of the EVOH layer is in a range of 12-22 micrometers (μm); and
a thickness of each of the second set of PE layers is in a range of 9-24 micrometers (μm).

9. The method according to claim 7, wherein the co-extruding of the defined number of layers is performed such that the co-extruded multi-layered peelable liner comprises the plurality of PE layer in the range of 40-65 weight percent (wt. %), the plurality of PA layers in the range of 10 to 25 wt. %, and the EVOH layer in the range of 5-25 wt. %.

10. The method according to claim 9, wherein the co-extruding of the defined number of layers is performed such that the co-extruded multi-layered peelable liner further comprises a plurality of intermediate tie layers in the range of 2-10 weight percent (wt. %).

11. The method according to claim 1, wherein the molded fiber structure has a first surface and a second surface, wherein the first surface is a product contact surface on which the multi-layered peelable liner is removably attached.

12. The method according to claim 11, further comprising aligning the multi-layered peelable liner held by a movable jig on the first surface of each of a plurality of molded fiber structures placed on a lamination mold assembly in a grid configuration.

13. The method according to claim 12, further comprising heating the multi-layered peelable liner using a heating assembly having a plurality of heating elements disposed above the multi-layered peelable liner, wherein a temperature of the plurality of heating elements is maintained at a temperature in a range of 600 degrees Celsius to 800 degrees Celsius.

14. The method according to claim 13, wherein a heating duration of the heating of the multi-layered peelable liner is 6-12 seconds.

15. The method according to claim 13, further comprising controlling a movement of the movable jig on which the multi-layered peelable liner is held, towards the lamination mold assembly on which the plurality of molded fiber structures is placed.

16. The method according to claim 13, further comprising applying vacuum suction pressure at the second surface of each molded fiber structure of the plurality of molded fiber structures such that a suction of the multi-layered peelable liner is caused through a plurality of perforations distributed across each of the plurality of molded fiber structures to removably attach and conform the heated multi-layered peelable liner on the first surface of each of the plurality of molded fiber structures, wherein the heating is continued during application of the vacuum suction pressure until the heated multi-layered peelable liner conforms on the first surface.

17. The method according to claim 16, wherein the vacuum suction pressure is applied for a suction time of 5-20 seconds.

18. The method according to claim 1, further comprising segregating a plurality of molded fiber structures at a trimming station on which the multi-layered peelable liner is removably attached by concurrent trimming of the multi-layered peelable liner at a surrounding region of each molded fiber structure.

19. The method according to claim 1, further comprising heat-sealing a lidding film on the MAP container along a peripheral edge of the MAP container when a food product is present in the MAP container.

20. The method according to claim 1, further comprising concurrently controlling three control parameters comprising:
a heating temperature to differentially adjust temperature of a plurality of heating elements distributed across each heating board in a heating assembly;
a vacuum suction pressure to allow the multi-layered peelable liner to uniformly adhere and conform on a first surface of the molded fiber structure while maintaining a peelability of the multi-layered peelable liner; and
a suction time to removably attach the multi-layered peelable liner to the first surface of the molded fiber structure.
